(19) United States
(12) Patent Application Publication
(10) Pub. No.: US 2026/0235888 A1
(43) Pub. Date: Aug. 13, 2026

(54) ELECTRONIC DEVICE AND OPERATING METHOD THEREOF

(71) Applicant: SAMSUNG ELECTRONICS CO., LTD., Suwon-si (KR)

(72) Inventors: Hyungki KIM, Suwon-si (KR); Youngjin JO, Suwon-si (KR); Hanjin PARK, Suwon-si (KR); Jaesung LEE, Suwon-si (KR)

(73) Assignee: SAMSUNG ELECTRONICS CO., LTD., Suwon-si (KR)

(21) Appl. No.: 19/554,143

(22) Filed: Mar. 2, 2026

Related U.S. Application Data
(63) Continuation of application No. PCT/KR2026/002455, filed on Feb. 10, 2026.

(30) Foreign Application Priority Data
Feb. 10, 2025 (KR) 10-2025-0016960

(51) Int. Cl. G02B 30/25; G02B 30/27; G02F 1/1335; G02F 1/1343

(52) U.S. Cl. CPC G02B 30/25; G02B 30/27; G02F 1/133526; G02F 1/133531; G02F 1/134309

(57) ABSTRACT

An electronic device includes a display, a polarization control array, a lens array, at least one processor, and memory. The electronic device generates, based on an input image and information about the two-dimensional display region and the three-dimensional display region of the input image, a polarization information map including at least one of a two-dimensional region corresponding to a two-dimensional display region or a three-dimensional region corresponding to a three-dimensional display region, and synchronizes the display and the polarization control array to simultaneously control the display to display an image based on the input image and control the polarization control array to control a liquid-crystal alignment of the polarization control array based on the polarization information map.

### CROSS-REFERENCE TO RELATED APPLICATIONS

This application is a Continuation Application of International Application PCT/KR2026/002455 filed on February 10, 2026, which claims benefit of Korean Patent Application No. 10-2025-0016960, filed on February 10, 2025, at the Korean Intellectual Property Office, the disclosures of which are incorporated herein in their entireties by reference.

### FIELD

The disclosure relates to an electronic device and an operating method of the electronic device. More particularly, the disclosure relates to an electronic device including an optical layer that includes a plurality of view regions and a display that includes a plurality of display regions corresponding to the plurality of view regions, and an operating method of the electronic device.

### BACKGROUND

With the development of electronic technology, various types of electronic devices have been developed and have become widespread. Electronic devices that include a display for displaying an image have been developing rapidly in recent years.

As electronic devices have developed, the types of images displayed thereon have also diversified. Electronic devices have been developed that may display not only two-dimensional (2D) images but also three-dimensional (3D) images.

Recently, electronic devices and methods have been proposed that display a 3D image by using refractive characteristics of an optical layer such as a lenticular lens. Electronic devices have been developed that provide a user with a stereoscopic image by using an optical layer to provide different images to the user’s left and right eyes, respectively.

### SUMMARY

An embodiment of the disclosure may provide an electronic device. The electronic device may include a display. The electronic device may include a lens array. The electronic device may include a polarization control array arranged between the display and the lens array and configured to control a polarization direction of light provided from the display. The electronic device may include at least one processor. The electronic device may include memory storing a plurality of instructions. The plurality of instructions, when executed by the at least one processor individually or collectively, may cause the electronic device to obtain an input image and information about a two-dimensional display region and a three-dimensional display region of the input image. The electronic device may generate, based on the obtained input image and the obtained information about the two-dimensional display region and the three-dimensional display region of the input image, a polarization information map including at least one of a two-dimensional region corresponding to the two-dimensional display region or a three-dimensional region corresponding to the three-dimensional display region. The electronic device may synchronize the display and the polarization control array to simultaneously control the display to display the image via the display based on the input image, and control the polarization control array to control a liquid-crystal alignment of the polarization control array based on the polarization information map. The electronic device may control the polarization control array such that a first liquid-crystal alignment in a two-dimensional control region of the polarization control array corresponding to the two-dimensional region is different from a second liquid-crystal alignment in a three-dimensional control region of the polarization control array corresponding to the three-dimensional region. The electronic device may provide the image that is displayed two-dimensionally in at least a portion or three-dimensionally in at least a portion, based on degrees of refraction of light beams in the lens array after passing through the two-dimensional control region and the three-dimensional control region, respectively, each of the light beams having a polarization direction distinct from that of another light beam.

An embodiment of the disclosure may provide an operating method of an electronic device. The electronic device may include a display, a lens array, and a polarization control array configured to control a polarization direction of light provided from the display. The operating method of the electronic device may include obtaining an input image and information about a two-dimensional display region and a three-dimensional display region of the input image. The operating method of the electronic device may include generating, based on the obtained input image and the obtained information about the two-dimensional display region and the three-dimensional display region of the input image, a polarization information map including at least one of a two-dimensional region corresponding to the two-dimensional display region or a three-dimensional region corresponding to the three-dimensional display region. The operating method of the electronic device may include synchronizing the display and the polarization control array to simultaneously control the display to display the image via the display based on the input image, and control the polarization control array to control a liquid-crystal alignment of the polarization control array based on the polarization information map. The operating method of the electronic device may include controlling the polarization control array such that a first liquid-crystal alignment in the two-dimensional control region of the polarization control array corresponding to the two-dimensional region is different from a second liquid-crystal alignment in the three-dimensional control region of the polarization control array corresponding to the three-dimensional region. The operating method of the electronic device may include providing the image that is displayed two-dimensionally in at least a portion or three-dimensionally in at least a portion, based on degrees of refraction of light beams in the lens array after passing through the two-dimensional control region and the three-dimensional control region, respectively, and each of the light beams having a different polarization direction distinct from that of another light beam.

An embodiment of the disclosure may provide a computer-readable recording medium having recorded thereon a program for causing a computer to execute at least one method of the operating methods of the disclosed electronic device.

The technical objectives of the disclosure are not limited to those mentioned above, and other technical objectives not mentioned herein may be clearly understood by those of skill in the art from descriptions below.

### BRIEF DESCRIPTION OF DRAWINGS

The disclosure may be understood with a combination of the following detailed descriptions and the accompanying drawings, wherein reference numbers refer to structural elements.

FIG. 1 is a block diagram of an electronic device according to an embodiment of the disclosure.

FIG. 2A is a diagram for describing an electronic device according to an embodiment of the disclosure.

FIG. 2B is a diagram illustrating an example of an image displayed by an electronic device, according to an embodiment of the disclosure.

FIG. 3A is a diagram illustrating an electronic device according to an embodiment of the disclosure.

FIG. 3B is a diagram illustrating a polarization control array according to an embodiment of the disclosure.

FIG. 4 is a diagram illustrating an electronic device according to an embodiment of the disclosure.

FIG. 5A is a flowchart for describing operations of an electronic device according to an embodiment of the disclosure.

FIG. 5B is a diagram for describing operations of an electronic device according to an embodiment of the disclosure.

FIG. 6 is a timing diagram for describing operations of an electronic device according to an embodiment of the disclosure.

FIG. 7A is a diagram for describing a plurality of input images corresponding to a plurality of display regions, respectively, according to an embodiment of the disclosure.

FIG. 7B is a diagram for describing an operation, performed by an electronic device, of generating a three-dimensional image, according to an embodiment of the disclosure.

FIG. 8A is a diagram for describing an operation, performed by an electronic device, of generating a polarization information map, according to an embodiment of the disclosure.

FIG. 8B is a diagram for describing an operation, performed by an electronic device, of generating a polarization information map, according to an embodiment of the disclosure.

FIG. 9 is a diagram for describing an operation, performed by an electronic device, of generating a polarization information map, according to an embodiment of the disclosure.

FIG. 10 is a diagram for describing an operation, performed by an electronic device, of generating a polarization information map, according to an embodiment of the disclosure.

FIG. 11 is a diagram for describing an operation, performed by an electronic device, of generating a polarization information map, according to an embodiment of the disclosure.

FIG. 12 is a diagram for describing an operation, performed by an electronic device, of generating a polarization information map, according to an embodiment of the disclosure.

FIG. 13A is a diagram for describing an operation, performed by an electronic device, of displaying an image based on a polarization information map, according to an embodiment of the disclosure.

FIG. 13B is a diagram for describing liquid-crystal alignments of a polarization control array according to an embodiment of the disclosure.

FIG. 13C is a diagram for describing an operation, performed by an electronic device, of displaying an image based on a polarization information map, according to an embodiment of the disclosure.

FIG. 14A is a diagram for describing an operation, performed by an electronic device, of displaying an image based on a polarization information map, according to an embodiment of the disclosure.

FIG. 14B is a diagram for describing liquid-crystal alignments of a polarization control array according to an embodiment of the disclosure.

FIG. 14C is a diagram for describing an operation, performed by an electronic device, of displaying an image based on a polarization information map, according to an embodiment of the disclosure.

FIG. 15 is a diagram for describing a planar structure of a polarization control array and a pixel array, according to an embodiment of the disclosure.

FIG. 16A is a diagram illustrating an electronic device according to an embodiment of the disclosure.

FIG. 16B is a diagram for describing an anisotropic diffuser film according to an embodiment of the disclosure.

### DETAILED DESCRIPTION

Terms used herein will be briefly described, and then an embodiment of the disclosure will be described in detail.

Throughout the disclosure, the expression “or” is inclusive and not exclusive, as long as there is no particular opposing recitation. Thus, the expression “A or B” may refer to “A, B, or both” as long as it is not inconsistent with the context.

As used herein, the expression “at least one of a, b, or c” may indicate only a, only b, only c, both a and b, both a and c, both b and c, all of a, b, and c, or variations thereof.

Although the terms used herein are selected from among common terms that are currently widely used in consideration of their functions in an embodiment of the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding description of an embodiment of the disclosure. Therefore, the terms used herein are not merely designations of the terms, but the terms are defined based on the meaning of the terms and content throughout the disclosure.

The singular expression may also include the plural meaning as long as it is not inconsistent with the context. All the terms used herein, including technical and scientific terms, may have the same meanings as those generally understood by those of skill in the art related to the specification.

Throughout the disclosure, when a part “includes” an element, it is to be understood that the part may additionally include other elements rather than excluding other elements as long as there is no particular opposing recitation. In addition, as used herein, the terms such as “...er (or)”, “... unit”, “... module”, etc., denote a unit that performs at least one function or operation, which may be implemented as hardware or software or a combination thereof.

As used herein, the expression “configured to” may be interchangeably used with, for example, “suitable for”, “having the capacity to”, “designed to”, “adapted to”, “made to”, or “capable of”, according to a situation. The expression “configured to” may not imply only “specially designed to” in a hardware manner. Instead, in a certain circumstance, the expression “a system configured to” may indicate the system “capable of” together with another device or components. For example, “a processor configured (or set) to perform A, B, and C” may imply a dedicated processor (e.g., an embedded processor) for performing a corresponding operation or a generic-purpose processor (e.g., central processing unit (CPU) or an application processor) capable of performing corresponding operations by executing one or more software programs stored in memory.

In addition, in the disclosure, it should be understood that when components are “connected” or “coupled” to each other, the elements may be directly connected or coupled to each other, but may alternatively be connected or coupled to each other with an element therebetween, unless specified otherwise.

It should be understood that blocks in each flowchart, and combinations of flowcharts may be performed by one or more computer programs including computer-executable instructions. The one or more computer programs may be all stored in a single memory unit, or may be divided and stored in a plurality of different memory units.

All functions or operations described herein may be performed by a single processor or a combination of processors.

Hereinafter, embodiments of the disclosure will be described in detail with reference to the accompanying drawings to allow those of skill in the art to easily carry out the embodiments. An embodiment of the disclosure may, however, be embodied in many different forms and should not be construed as being limited to the embodiment of the disclosure set forth herein. Furthermore, in the drawings, portions that are irrelevant to the description are omitted to clearly describe an embodiment of the disclosure, and like reference numerals are assigned to like elements throughout the disclosure.

Hereinafter, embodiments of the disclosure will be described in detail with reference to the drawings.

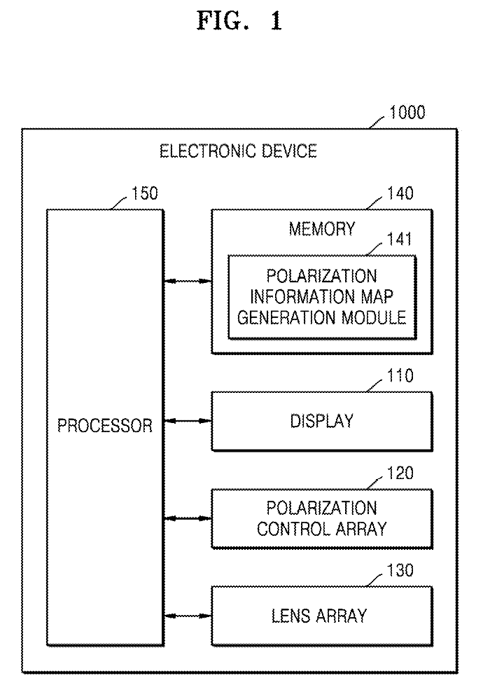

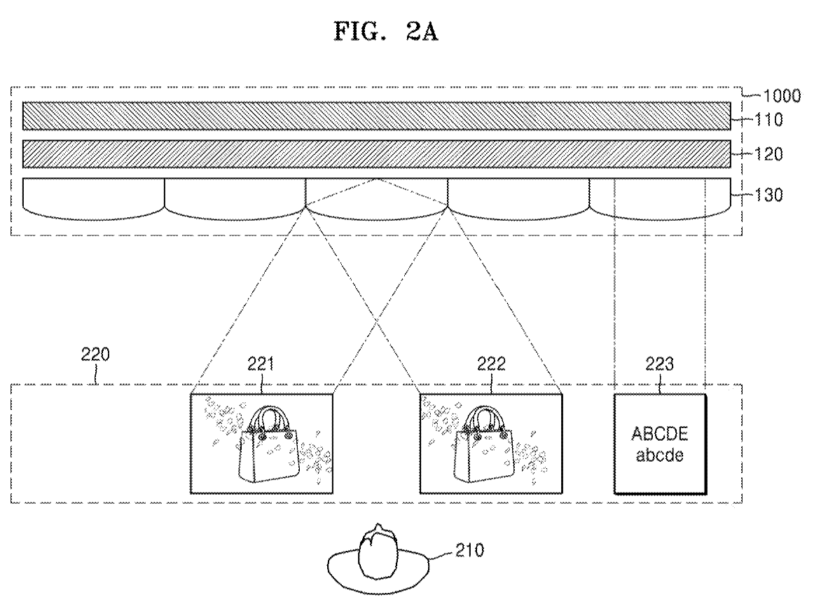

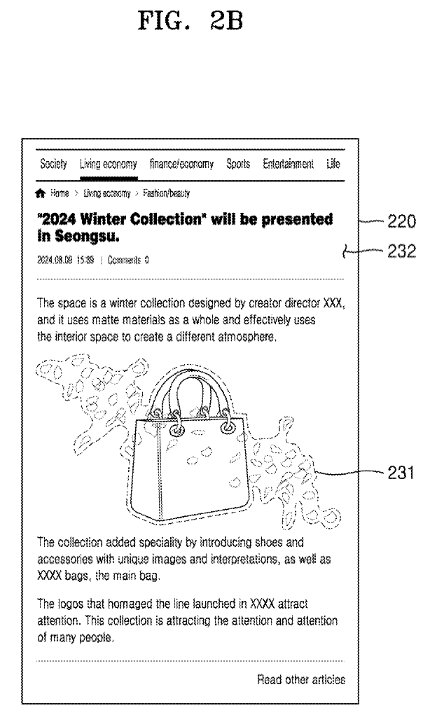

FIG. 1 is a block diagram of an electronic device 1000 according to an embodiment of the disclosure. FIG. 2A is a diagram for describing the electronic device 1000 according to an embodiment of the disclosure. FIG. 2B is a diagram illustrating an example of an image displayed by the electronic device 1000, according to an embodiment of the disclosure.

In an embodiment of the disclosure, the electronic device 1000 may be implemented as various types of electronic devices, such as a mobile device, a smart phone, a monitor, a laptop computer, a tablet personal computer (PC), a wearable device, a head-mounted display (HMD) device, or a digital signage.

In an embodiment of the disclosure, the electronic device 1000 may include a display 110, a polarization control array 120, a lens array 130, memory 140, and a processor 150. However, not all of the components illustrated in FIG. 1 are essential components. The electronic device 1000 may be implemented with more or fewer components than those illustrated in FIG. 1. The display 110, the polarization control array 120, the lens array 130, the memory 140, and the processor 150 may be electrically and/or physically connected to each other.

The display 110 may display various types of content, such as text, images, videos, icons, or symbols. According to an embodiment of the disclosure, the display 110 may include at least one of a liquid-crystal display (LCD), a light-emitting diode (LED) display, an organic LED (OLED) display, a micro-LED display, a digital micromirror device (DMD), or a liquid-crystal-on-silicon (LCoS) display. However, the disclosure is not limited thereto, and the display 110 may include other types of displays capable of providing an output image to a user.

The electronic device 1000 may control the polarization angle of polarized light incident on the polarization control array 120. According to an embodiment of the disclosure, the electronic device 1000 may control the polarization angle by varying a polarization angle shift for each region of the polarization control array 120 on which polarized light is incident.

In an embodiment of the disclosure, the electronic device 1000 may generate a polarization information map based on a received input image. The electronic device 1000 may control the polarization control array 120 based on the polarization information map. The electronic device 1000 may control the polarization control array 120 such that a voltage is either applied or not applied to each unit cell of the polarization control array 120 in correspondence with the polarization information map.

For example, the electronic device 1000 may, while not changing the polarization angle of light incident on a first control region (e.g., a region intended to two-dimensionally display an image) of the polarization control array 120, change the polarization angle of light incident on a second control region (e.g., a region intended to three-dimensionally display an image) of the polarization control array 120 by a certain angle. The electronic device 1000 may control the polarization control array 120 such that the first control region and the second control region of the polarization control array 120 have different liquid-crystal alignments. In the disclosure, the first control region may be referred to as a two-dimensional control region, and the second control region may be referred to as a three-dimensional control region.

For example, the electronic device 1000 may, while not changing the polarization angle of light incident on a first control region (e.g., a region intended to two-dimensionally display an image) of the polarization control array 120, change the polarization angle of light incident on a second control region (e.g., a region intended to three-dimensionally display an image) of the polarization control array 120 by a first angle, and change the polarization angle of light incident on a third control region (e.g., a region corresponding to a boundary between the first control region and the second control region) by a second angle that is different from the first angle. The electronic device 1000 may control the polarization control array 120 such that the first control region, the second control region, and the third control region of the polarization control array 120 have different liquid-crystal alignments. In the disclosure, the first control region may be referred to as a two-dimensional control region, the second control region may be referred to as a three-dimensional control region, and the third control region may be referred to as a boundary control region.

In an embodiment of the disclosure, the polarization control array 120 may be implemented as a liquid-crystal spatial light modulator (LCSLM). Alternatively, the polarization control array 120 may be formed by removing a color filter and a black matrix from an LCD, but is not limited thereto.

In an embodiment of the disclosure, the polarization control array 120 may include a liquid-crystal layer that is driven in a vertical alignment (VA) mode. In an embodiment of the disclosure, the polarization control array 120 may include a liquid-crystal layer that is driven in a twisted nematic (TN) mode. However, embodiments of the disclosure are not limited thereto.

The lens array 130 may include a viewing zone separator, such as a lenticular lens, which allows a user to see different images depending on a viewing position. According to an embodiment of the disclosure, the lens array 130 may include a plurality of lenticular lenses having different pattern angles to achieve a precise parallax.

In an embodiment of the disclosure, a lenticular lens included in the lens array 130 may include a material having birefringent properties. Accordingly, whether light is refracted by the lens array 130 may depend on the polarization direction of the light passing through the polarization control array 120. Light that has not been refracted while passing through the lens array 130 may provide a two-dimensional image to a user, whereas light that has been refracted while passing through the lens array 130 may provide a three-dimensional image to the user. The two-dimensional image may be perceived by the user as a planar image, and the three-dimensional image may be perceived by the user as a stereoscopic image.

According to an embodiment of the disclosure, the lenticular lens may include a liquid-crystal material aligned in a particular direction. For example, the liquid-crystal material included in the lenticular lens may be aligned in a direction perpendicular to the polarization axis of a polarizing layer (or a polarizing plate) included in the display 110. For example, the liquid-crystal material included in the lenticular lens may be aligned in a direction parallel to the polarization axis of a polarizing layer (or a polarizing plate) included in the display 110.

In an embodiment of the disclosure, the memory 140 may include at least one of flash memory-type memory, hard disk-type memory, multimedia card micro-type memory, card-type memory (e.g., SD or XD memory), random-access memory (RAM), static RAM (SRAM), read-only memory (ROM), electrically erasable programmable ROM (EEPROM), programmable ROM (PROM), mask ROM, flash ROM, a hard disk drive (HDD), or a solid-state drive (SSD). Instructions or program code for performing functions or operations of the electronic device 1000 may be stored in the memory 140. Instructions, algorithms, data structures, program code, and application programs stored in the memory 140 may be implemented in a programming or scripting language, such as C, C++, Java, or assembler.

In an embodiment of the disclosure, the memory 140 may store various types of modules that may be used to provide an output image to a user via the display 110. For example, a polarization information map generation module 141 may be stored in the memory 140. However, the module illustrated in FIG. 1 is not an essential module. More modules than that illustrated in FIG. 1 may be stored in the memory 140.

A ‘module’ included in the memory 140 may refer to a unit that processes a function or operation performed by the processor 150. A ‘module’ included in the memory 140 may be implemented as software, such as instructions, algorithms, data structures, or program code.

In an embodiment of the disclosure, the polarization information map generation module 141 may store instructions for generating a polarization information map that includes polarization information required for each region (e.g., each cell), to control the polarization control array 120 on a region-by-region (e.g., cell-by-cell) basis. The polarization information map generation module 141 may receive an input image. The polarization information map generation module 141 may generate a polarization information map based on the received input image.

According to an embodiment of the disclosure, the polarization information map may include a two-dimensional region, which corresponds to a portion of an input image to be perceived by the user as a two-dimensional image, and a three-dimensional region, which corresponds to a portion of the input image to be perceived by the user as a three-dimensional image.

In an embodiment of the disclosure, based on the polarization information map, the electronic device 1000 may, while not applying a voltage to a three-dimensional control region (or a second control region) of the polarization control array 120 corresponding to the three-dimensional region, apply a voltage to a two-dimensional control region (or a first control region) of the polarization control array 120 corresponding to the two-dimensional region.

In an embodiment of the disclosure, based on the polarization information map, the electronic device 1000 may, while not applying a voltage to a two-dimensional control region (or a first control region) of the polarization control array 120 corresponding to the two-dimensional region, apply a voltage to a three-dimensional control region (or a second control region) of the polarization control array 120 corresponding to the three-dimensional region. Whether to apply a voltage to the two-dimensional control region or the three-dimensional control region may depend on a liquid-crystal alignment mode of the polarization control array.

According to an embodiment of the disclosure, the polarization information map may further include a boundary region between the two-dimensional region and the three-dimensional region. By providing the boundary region, the polarization information map may mitigate image distortion, double image, or crosstalk that may occur during off-axis viewing.

In an embodiment of the disclosure, based on the polarization information map, the electronic device 1000 may, while not applying a voltage to a three-dimensional control region (or a second control region) of the polarization control array 120 corresponding to the three-dimensional region, apply a first voltage to a two-dimensional control region (or a first control region) of the polarization control array 120 corresponding to the two-dimensional region, and apply a second voltage, which has an absolute value less than that of the first voltage, to a boundary control region (or a third control region) of the polarization control array 120 corresponding to the boundary region. The second voltage may be an intermediate value of the first voltage. The second voltage may have a value between zero and the first voltage.

In an embodiment of the disclosure, based on the polarization information map, the electronic device 1000 may, while not applying a voltage to a two-dimensional control region (or a first control region) of the polarization control array 120 corresponding to the two-dimensional region, apply a first voltage to a three-dimensional control region (or a second control region) of the polarization control array 120 corresponding to the two-dimensional region, and apply a second voltage, which has an absolute value less than that of the first voltage, to a boundary control region (or a third control region) of the polarization control array 120 corresponding to the boundary region. The second voltage may be an intermediate value of the first voltage. For example, the second voltage may have a value between zero and the first voltage. Whether to apply a voltage to the two-dimensional control region or the three-dimensional control region may depend on a liquid-crystal alignment mode of the polarization control array 120.

In an embodiment of the disclosure, the electronic device 1000 may further include an image driver. The image driver may control the operation of the display 110. The image driver may be integrated as part of the processor 150 or may be a component within the electronic device 1000 that is separate from the processor 150.

The image driver may control the display 110 to display an input image. The image driver may input, to the display 110, image data (or visual data) regarding the obtained input image. In an embodiment of the disclosure, the image driver may include a timing controller, a gate driver, and a data driver. The timing controller may receive data regarding the input image, and an input control signal. The timing controller may generate at least one scan signal and at least one data signal based on the data regarding the input image and the input control signal. The gate driver may generate gate signals for driving gate lines in response to a control signal received from the timing controller. The data driver may output a data voltage to data lines in response to a control signal received from the timing controller.

In an embodiment of the disclosure, the electronic device 1000 may further include a polarization control driver. The polarization control driver may control the operation of the polarization control array 120. The polarization control driver may be integrated as part of the processor 150 or may be a component within the electronic device 1000 that is separate from the processor 150.

The polarization control driver may control the polarization control array 120 to control the polarization direction of polarized light provided from the display 110. The polarization control driver may input the polarization information map to the polarization control array 120. In an embodiment of the disclosure, the polarization control driver may control a voltage applied to each region (or each unit cell) of the polarization control array 120, based on the polarization information map.

The processor (150) may execute one or more instructions of a program stored in the memory (140). The processor (150) may be configured of hardware components that perform arithmetic, logic, and input/output operations and image processing. Although the processor (150) is illustrated as a single element in FIG. 1, it is not limited thereto. In one embodiment of the present disclosure, the processor (150) may be composed of one or more plural elements.

The processor (150) may include a processing circuitry and/or a plurality of processors. For example, the term “processor” used in the present disclosure, including the claims, may include various processing circuitries including at least one processor. Of the at least one processor, one or more processors may be configured to perform, individually and/or collectively, various functions and/or operations described in the present disclosure in a distributed manner. As used herein, the terms “processor,” “at least one processor,” and “one or more processors” may be configured to perform various functions. However, these terms cover, without limitation, a situation in which one processor performs some of the functions and another processor(s) performs other parts of the functions, and a situation in which a single processor performs all of the functions. In addition, the at least one processor may include a combination of processors that perform various functions of the disclosed functions in a distributed manner. The at least one processor may execute program code or instructions to achieve or perform various functions.

The processor 150 may include at least one of a CPU, a microprocessor, a graphics processing unit, an application processor (AP), an application-specific integrated circuit (ASIC), a digital signal processor (DSP), a digital signal processing device (DSPD), a programmable logic device (PLD), a field-programmable gate array (FPGA), a neural processing unit, or a dedicated artificial intelligence processor designed with a hardware structure specialized for training and processing of an artificial intelligence (AI) model, but is not limited thereto.

In an embodiment of the disclosure, the processor 150 may execute various types of modules stored in the memory 140. In an embodiment of the disclosure, the processor 150 may execute the polarization information map generation module 141 stored in the memory 140. In an embodiment of the disclosure, the processor 150 may execute at least one instruction that constitutes various types of modules stored in the memory 140.

The processor 150 may control the overall operation of the electronic device 1000 by executing at least one instruction stored in the memory 140.

In an embodiment of the disclosure, a plurality of instructions, when executed by at least one processor 150 individually or collectively, may cause the electronic device 1000 to obtain an input image and information about a two-dimensional display region and a three-dimensional display region of the input image.

In an embodiment of the disclosure, the plurality of instructions, when executed by the at least one processor 150 individually or collectively, may cause the electronic device 1000 to generate, based on the obtained input image and the information about the two-dimensional display region and the three-dimensional display region of the obtained input image, a polarization information map including at least one of a two-dimensional region corresponding to the two-dimensional display region or a three-dimensional region corresponding to the three-dimensional display region.

In an embodiment of the disclosure, the plurality of instructions, when executed by the at least one processor 150 individually or collectively, may cause the electronic device 1000 to synchronize the display and the polarization control array to simultaneously control the display to display an image based on the input image, and control the polarization control array to control a liquid-crystal alignment of the polarization control array based on the polarization information map.

In an embodiment of the disclosure, the plurality of instructions, when executed by the at least one processor 150 individually or collectively, may cause the electronic device 1000 to control the polarization control array such that a first liquid-crystal alignment in a two-dimensional control region of the polarization control array corresponding to the two-dimensional region is different from a second liquid-crystal alignment in a three-dimensional control region of the polarization control array corresponding to the three-dimensional region.

In an embodiment of the disclosure, the plurality of instructions, when executed by the at least one processor 150 individually or collectively, may cause the electronic device 1000 to provide the image that is displayed two-dimensionally in at least a portion or three-dimensionally in at least a portion, based on degrees of refraction of light beams in the lens array passing through the two-dimensional control region and the three-dimensional control region, respectively, each of the light beams having a polarization direction distinct from that of another light beam.

According to an embodiment of the disclosure, the electronic device 1000 may drive the polarization control array 120 in synchronization with the display 110 each time a frame of an image to be output is displayed, such that two-dimensional and three-dimensional representations in each frame may be more accurately implemented even when regions to be displayed in two dimensions and three dimensions are changed in real time.

In an embodiment of the disclosure, the electronic device 1000 may set a boundary region between the two-dimensional region and the three-dimensional region within the polarization information map. In an embodiment of the disclosure, based on the polarization information map, the electronic device 1000 may apply a first voltage to the three-dimensional region or the two-dimensional region of the polarization control array 120, and apply a second voltage, which has a value between zero and the first voltage, i.e., has an intermediate value of the first voltage, to the boundary region of the polarization control array 120.

In an embodiment of the disclosure, the display region may include a first display region and a second display region, and the input image may include a first input image to be displayed in the first display region, and a second input image to be displayed in the second display region. In an embodiment of the disclosure, the electronic device 1000 may identify the two-dimensional display region based on detecting identical pixel value information at corresponding pixels between the first input image and the second input image, and identify the three-dimensional display region based on detecting a difference in pixel value information at corresponding pixels between the first input image and the second input image.

In an embodiment of the disclosure, the electronic device 1000 may receive image data including a first label value assigned to pixels corresponding to the two-dimensional display region, and a second label value assigned to pixels corresponding to the three-dimensional display region in the input image.

In an embodiment of the disclosure, the electronic device 1000 may identify visual content in the input image. In an embodiment of the disclosure, the electronic device 1000 may identify the three-dimensional display region in the input image based on the identified visual content.

In an embodiment of the disclosure, the electronic device 1000 may obtain information about a preset three-dimensional display region in the input image. In an embodiment of the disclosure, the electronic device 1000 may identify the three-dimensional display region based on the information about the preset three-dimensional display region.

In an embodiment of the disclosure, the electronic device 1000 may activate a synchronization signal after the polarization information map is generated. In an embodiment of the disclosure, the electronic device 1000 may activate and input a first scan signal to the display 110 in synchronization with the synchronization signal, and activate and input a second scan signal to the polarization control array 120 in synchronization with the synchronization signal.

In an embodiment of the disclosure, the display 110 may include a first polarizing plate, a second polarizing plate having a polarization axis in a first polarization direction, and a first liquid-crystal layer arranged between the first polarizing plate and the second polarizing plate. In an embodiment of the disclosure, the lens array 130 may include a liquid-crystal lens aligned in a direction orthogonal to the first polarization direction.

In an embodiment of the disclosure, the display 110 may include a display element layer including a light-emitting element, and an upper polarizing plate arranged on the display element layer and having a polarization axis in a first polarization direction. In an embodiment of the disclosure, the lens array 130 may include a liquid-crystal lens aligned in a direction orthogonal to the first polarization direction.

In an embodiment of the disclosure, the polarization control array 120 may include a second liquid-crystal layer that is driven in a VA mode. In an embodiment of the disclosure, based on the polarization information map, the electronic device 1000 may apply no voltage to the two-dimensional control region of the polarization control array 120 corresponding to the two-dimensional region, and apply a voltage to the three-dimensional control region of the polarization control array 120 corresponding to the three-dimensional region.

In an embodiment of the disclosure, the display 110 may include a plurality of pixels, each of the plurality of pixels including a first sub-pixel that provides light of a first color, a second sub-pixel that provides light of a second color, and a third sub-pixel that provides light of a third color. In an embodiment of the disclosure, the polarization control array 120 may include a plurality of first electrodes and a plurality of second electrodes that intersect the plurality of first electrodes on a plane. In an embodiment of the disclosure, a first width, in a first direction, of each of cells defined by the plurality of first electrodes and the plurality of second electrodes intersecting each other, and a second width, in the first direction, of each of the plurality of pixels may be such that neither is an integer multiple of the other. In an embodiment of the disclosure, a third width of each of the cells in a second direction that is orthogonal to the first direction, and a fourth width of each of the plurality of pixels in the second direction may be such that neither is an integer multiple of the other.

In an embodiment of the disclosure, the electronic device 1000 may further include an anisotropic diffuser film arranged between the display 110 and the polarization control array 120. In an embodiment of the disclosure, the display 110 may include a plurality of pixels, each including a first sub-pixel that provides light of a first color, a second sub-pixel that provides light of a second color, and a third sub-pixel that provides light of a third color. In an embodiment of the disclosure, in each of the plurality of pixels, the first sub-pixel, the second sub-pixel, and the third sub-pixel may be arranged in a first direction, and the first sub-pixels, the second sub-pixels, and the third sub-pixels of the plurality of pixels may be respectively arranged in a second direction that is orthogonal to the first direction. In an embodiment of the disclosure, a degree of diffusion of light by the anisotropic diffuser film in the second direction may be greater than a degree of diffusion of light by the anisotropic diffuser film in the first direction.

Referring to FIGS. 2A and 2B, the electronic device 1000 according to an embodiment of the disclosure may display an output image 220 via the display 110. In an embodiment of the disclosure, the output image 220 provided by the electronic device 1000 may be an image that provides a three-dimensional effect to a user 210.

In an embodiment of the disclosure, the output image 220 provided by the electronic device 1000 may be an image that provides a three-dimensional effect to the user 210 in only a partial region thereof. As illustrated in FIG. 2B, the output image 220 provided by the electronic device 1000 may be a combination of a region 231 displayed in three dimensions and a region 232 displayed in two dimensions.

In an embodiment of the disclosure, the electronic device 1000 may provide different output images 221 and 222 to the left eye and the right eye of the user 210, respectively, such that the user 210 perceives a binocular disparity. The user 210 may perceive a binocular disparity because the output images 221 and 222 provided to the right and left eyes are different from each other, and accordingly, perceive a three-dimensional effect of an object.

In an embodiment of the disclosure, the electronic device 1000 may provide an identical output image 223 to both the left eye and the right eye of the user, such that the user may perceive a planar shape.

According to an embodiment of the disclosure, the electronic device 1000 may provide, as a three-dimensional image, only a region of the output image 220 that requires a three-dimensional effect, and provide, as a two-dimensional image, a region of the output image 220 that requires high resolution, such as text. Thus, the electronic device 1000 may provide small-sized text at a relatively high resolution, and thus may provide a region that requires information that is delivered at a high resolution.

However, embodiments of the disclosure are not limited thereto, and the output image 220 provided by the electronic device 1000 may be a three-dimensional image or a two-dimensional image over its entire region.

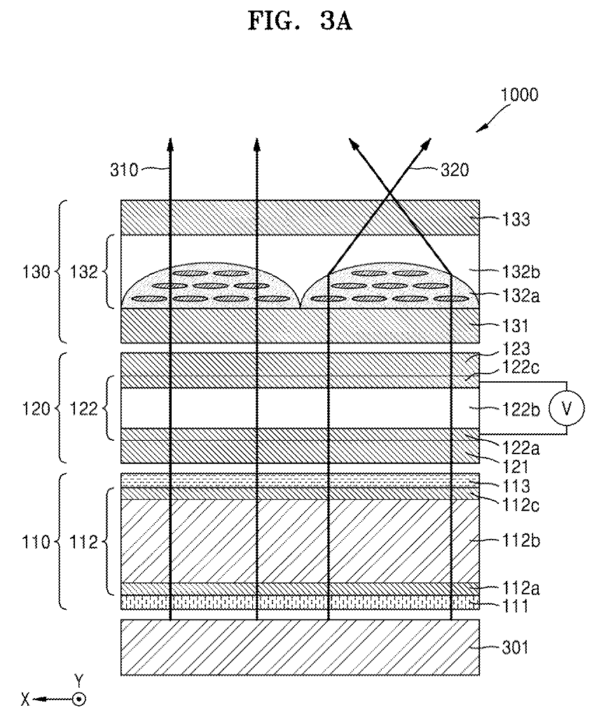

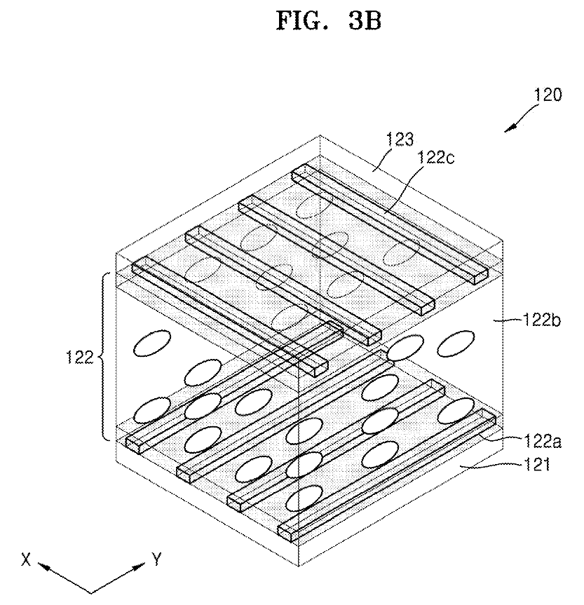

FIG. 3A is a diagram illustrating an electronic device according to an embodiment of the disclosure. FIG. 3B is a diagram illustrating a polarization control array according to an embodiment of the disclosure.

Referring to FIGS. 3A and 3B, the electronic device 1000 according to an embodiment of the disclosure may include a backlight unit 301, the display 110, the polarization control array 120, and the lens array 130.

The backlight unit 301 may be arranged below the display 110. The backlight unit 301 may provide light to the display 110. Light emitted from the backlight unit 301 may have a certain wavelength range. For example, the light emitted from the backlight unit 301 may be ultraviolet (UV) light or blue light. In a case in which light is emitted from a side surface of the backlight unit 301, the electronic device 1000 may further include a light guide plate that guides the light to one surface (e.g., a side surface) of the backlight unit 301.

The display 110 may form an image by modulating the light emitted from the backlight unit 301. In an embodiment of the disclosure, the display 110 may be an LCD. The display 110 according to an embodiment of the disclosure may include a first polarizing plate 111, a first liquid-crystal cell 112, and a second polarizing plate 113. The first liquid-crystal cell 112 may be arranged between the first polarizing plate 111 and the second polarizing plate 113. In the disclosure, the first polarizing plate 111 may be referred to as a lower polarizing plate, and the second polarizing plate 113 may be referred to as an upper polarizing plate. In the disclosure, the first liquid-crystal cell 112 may be referred to as a main cell or a lower cell.

The first polarizing plate 111 may transmit light of a first polarization and absorb light of other polarizations, and the second polarizing plate 113 may transmit light of a second polarization and absorb light of other polarizations. The optical axes of the first polarizing plate 111 and the second polarizing plate 113 may be orthogonal to each other. For example, the optical axis of the first polarizing plate 111 may be a vertical direction of the liquid-crystal panel, i.e., the Y-direction in the drawings, and the optical axis of the second polarizing plate 113 may be a horizontal direction of the liquid-crystal panel, i.e., the X-direction in the drawings.

In an embodiment of the disclosure, the first liquid-crystal cell 112 may include a first electrode layer 112a (or a first upper electrode), a first liquid-crystal layer 112b, and a second electrode layer 112c (or a first lower electrode). The first liquid-crystal layer 112b may be arranged between the first electrode layer 112a and the second electrode layer 112c. An electric field may be formed in the first liquid-crystal layer 112b due to a difference between voltages applied to the first electrode layer 112a and the second electrode layer 112c, thereby changing the liquid-crystal alignment of the first liquid-crystal layer 112b.

In an embodiment of the disclosure, the first electrode layer 112a may include a plurality of driving electrodes that are spaced apart from each other. The driving electrodes may receive a driving voltage. The first electrode layer 112a may include a transparent conductive material. The second electrode layer 112c may be an electrode formed on the entire surface of the display 110. The second electrode layer 112c may receive a common voltage. The second electrode layer 112c may include a transparent conductive material.

The first liquid-crystal layer 112b may include a plurality of liquid-crystal molecules. The plurality of liquid-crystal molecules included in the first liquid-crystal layer 112b may be distributed with a uniform density throughout the entire region of the first liquid-crystal layer 112b.

The first liquid-crystal layer 112b may be controlled such that the alignment of the liquid-crystal molecules that constitute the first liquid-crystal layer 112b is changed in accordance with a voltage applied to the first liquid-crystal cell 112. The first liquid-crystal layer 112b may control light incident on the first liquid-crystal layer 112b, according to an alignment state of the liquid-crystal molecules. For example, according to the alignment state of the liquid-crystal molecules, the first liquid-crystal layer 112b may change or not change the polarization direction of light incident on the first liquid-crystal layer 112b.

In an embodiment of the disclosure, the first liquid-crystal layer 112b may be aligned in a normally white mode. The first liquid-crystal layer 112b may transmit incident light when no voltage is applied, and may not transmit incident light when a voltage is applied. For example, the first liquid-crystal layer 112b may be aligned in a TN mode. When no voltage is applied to the first liquid-crystal cell 112, the liquid-crystal molecules of the first liquid-crystal layer 112b may be aligned parallel to the first polarizing plate 111 and the second polarizing plate 113, and gradually twisted (or rotated) from the first polarizing plate 111 to the second polarizing plate 113. When a voltage is applied to the first liquid-crystal cell 112, the alignment direction of the liquid-crystal molecules of the first liquid-crystal layer 112b may change such that the liquid-crystal molecules are aligned in a direction perpendicular to the first polarizing plate 111 and the second polarizing plate 113.

In an embodiment of the disclosure, the first liquid-crystal layer 112b may be aligned in a normally black mode. The first liquid-crystal layer 112b may not transmit incident light when no voltage is applied, and may transmit incident light when a voltage is applied. For example, the first liquid-crystal layer 112b may be aligned in a VA mode. When no voltage is applied to the first liquid-crystal cell 112, the liquid-crystal molecules of the first liquid-crystal layer 112b may be aligned perpendicularly to the first polarizing plate 111 and the second polarizing plate 113. When a voltage is applied to the first liquid-crystal cell 112, the alignment direction of the liquid-crystal molecules of the first liquid-crystal layer 112b may change such that the liquid-crystal molecules are aligned parallel to the first polarizing plate 111 and the second polarizing plate 113.

Although not illustrated, the display 110 may further include a color filter arranged on the second polarizing plate 113. Although not illustrated, the display 110 may further include a thin-film transistor (TFT) for driving individual pixels.

As illustrated in FIGS. 3A and 3B, in an embodiment of the disclosure, the polarization control array 120 may include a first glass substrate 121, a second liquid-crystal cell 122, and a second glass substrate 123. The second liquid-crystal cell 122 may be arranged between the first glass substrate 121 and the second glass substrate 123. In the disclosure, the first glass substrate 121 may be referred to as a first lower glass substrate, and the second glass substrate 123 may be referred to as a first upper glass substrate. In the disclosure, the second liquid-crystal cell 122 may be referred to as an upper liquid-crystal cell, a polarization switching cell, or a liquid-crystal cell.

In an embodiment of the disclosure, the second liquid-crystal cell 122 may further include a third electrode layer 122a, a second liquid-crystal layer 122b, and a fourth electrode layer 122c. The second liquid-crystal layer 122b may be arranged between the third electrode layer 122a and the fourth electrode layer 122c. An electric field may be formed in the second liquid-crystal layer 122b due to a difference between voltages applied to the third electrode layer 122a and the fourth electrode layer 122c, thereby changing the liquid-crystal alignment of the second liquid-crystal layer 122b. In the disclosure, the third electrode layer 122a may be referred to as a lower electrode layer, and the fourth electrode layer 122c may be referred to as an upper electrode layer.

The third electrode layer 122a may include a plurality of lower electrodes arranged in an X-direction (or a first direction). Each of the plurality of lower electrodes may extend in a Y-direction (or a second direction) that is orthogonal to the X-direction (or the first direction). The fourth electrode layer 122c may include a plurality of upper electrodes arranged in the Y-direction (or the second direction). Each of the plurality of upper electrodes may extend in the X-direction (or the first direction).

The second liquid-crystal layer 122b may include a plurality of liquid-crystal molecules. The plurality of liquid-crystal molecules included in the second liquid-crystal layer 122b may be distributed with a uniform density throughout the entire region of the second liquid-crystal layer 122b.

The second liquid-crystal layer 122b may be controlled such that the alignment of the liquid-crystal molecules that constitute the second liquid-crystal layer 122b is changed in accordance with an applied voltage. The second liquid-crystal layer 122b may control light incident on the second liquid-crystal layer 122b according to an alignment state of the liquid-crystal molecules. For example, according to the alignment state of the liquid-crystal molecules, the second liquid-crystal layer 122b may change or not change the polarization direction of light incident on the second liquid-crystal layer 122b.

In an embodiment of the disclosure, the second liquid-crystal layer 122b may transmit incident light when no voltage is applied, and may not transmit incident light when a voltage is applied. For example, the second liquid-crystal layer 122b may be aligned in a TN mode. When no voltage is applied to the second liquid-crystal cell 122, the liquid-crystal molecules of the second liquid-crystal layer 122b may be aligned parallel to the first glass substrate 121 and the second glass substrate 123, and gradually twisted (or rotated) from the first glass substrate 121 to the second glass substrate 123. When a voltage is applied to the second liquid-crystal cell 122, the alignment direction of the liquid-crystal molecules of the second liquid-crystal layer 122b may change such that the liquid-crystal molecules are aligned in a direction perpendicular to the first glass substrate 121 and the second glass substrate 123.

In an embodiment of the disclosure, the second liquid-crystal layer 122b may not transmit incident light when no voltage is applied, and may transmit incident light when a voltage is applied. For example, the second liquid-crystal layer 122b may be arranged in a VA mode. When no voltage is applied to the second liquid-crystal cell 122, the liquid-crystal molecules of the second liquid-crystal layer 122b may be aligned perpendicularly to the first glass substrate 121 and the second glass substrate 123. When a voltage is applied to the second liquid-crystal cell 122, the alignment direction of the liquid-crystal molecules of the second liquid-crystal layer 122b may change such that the liquid-crystal molecules are aligned parallel to the first glass substrate 121 and the second glass substrate 123.

In an embodiment of the disclosure, the polarization control array 120 may further include a first high-resistance film arranged between a first conductive layer and the second liquid-crystal layer 122b, and a second high-resistance film arranged between a second conductive layer and the second liquid-crystal layer 122b. The first high-resistance film may be arranged on the first glass substrate 121 to cover the first conductive layer. The second high-resistance film may be arranged below the second glass substrate 123 to cover the second conductive layer. A voltage difference between cells may be precisely adjusted via the first high-resistance film and the second high-resistance film.

In an embodiment of the disclosure, the lens array 130 may include a third glass substrate 131, a liquid-crystal lens 132, and a fourth glass substrate 133. In the disclosure, the third glass substrate 131 may be referred to as a second lower glass substrate, and the fourth glass substrate 133 may be referred to as a second upper glass substrate.

In an embodiment of the disclosure, the liquid-crystal lens 132 may include lenses 132a and a resin layer 132b. The lenses 132a may be arranged between the third glass substrate 131 and the fourth glass substrate 133. The resin layer 132b may be arranged between the third glass substrate 131 and the fourth glass substrate 133. The resin layer 132b may cover the lenses 132a.

In an embodiment of the disclosure, the liquid-crystal lens 132 may include the lenticular lenses 132a that include lenses having a lenticular shape. For example, the lenticular lenses 132a may be arranged to be slanted relative to a plurality of pixels included in the display 110. Here, the phrase ‘arranged to be slanted’ may mean that each of the plurality of lenticular lenses 132a included in the lens array 130 overlaps with, among the plurality of pixels included in the display 110, pixels located in different rows and columns, rather than with pixels located in a single row or column.

In an embodiment of the disclosure, the lenses 132a may include a material having birefringent properties. For example, each of the lenses 132a may include a plurality of liquid-crystal molecules. The plurality of liquid-crystal molecules included in each of the lenticular lenses 132a may be distributed with a uniform density throughout the entire region of the lens 132a. The lenses 132a may be anisotropic. The liquid-crystal molecules included in the lenses 132a may be aligned in a particular direction. In the lenses 132a, a refractive index of the liquid-crystal molecules in the long-axis direction, e.g., a direction parallel to the long axes of rod-like liquid-crystal molecules in the lenses 132a, may be different from refractive indices in directions other than the long-axis direction. The refractive index of the lenses 132a may vary depending on the polarization direction of incident light.

Depending on the polarization direction of incident light, the refractive index of the lenses 132a may be identical to the refractive index of the resin layer 132b, in which case light passing through the lenses 132a may not be refracted. Unrefracted light 310 may provide a two-dimensional image to the user. Depending on the polarization direction of incident light, the refractive index of the lenses 132a may be different from the refractive index of the resin layer 132b, in which case light passing through the lenses 132a may be refracted. Refracted light 320 may provide a three-dimensional image to the user.

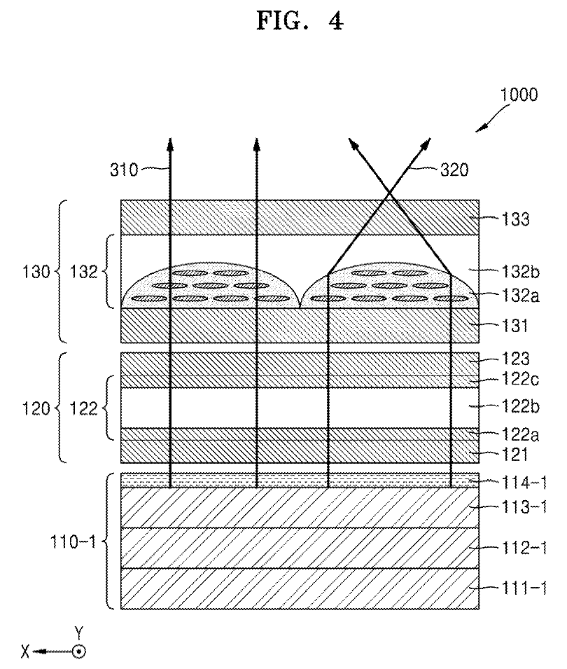

FIG. 4 is a diagram illustrating an electronic device according to an embodiment of the disclosure. Hereinafter, a detailed description of configurations that are the same as those described above with reference to FIG. 3 will be omitted.

Referring to FIG. 4, the electronic device 1000 according to an embodiment of the disclosure may include a display 110-1, the polarization control array 120, and the lens array 130. In an embodiment of the disclosure, the display 110-1 may be an OLED display. The display 110-1 may include a base layer 111-1, a circuit element layer 112-1 arranged on the base layer 111-1, a display element layer 113-1 arranged on the circuit element layer 112-1, and a polarizing plate 114-1 arranged on the display element layer 113-1. In the disclosure, the polarizing plate 114-1 included in the OLED display 110-1 may be referred to as an upper polarizing plate 114-1. Hereinafter, the polarizing plate 114-1 included in the display 110-1 will be referred to as the upper polarizing plate 114-1.

The base layer 111-1 may include a synthetic resin film. A synthetic resin layer may be formed on a working substrate that is used for manufacturing the display 110-1. Subsequently, a conductive layer, an insulating layer, and the like may be formed on the synthetic resin layer. When the working substrate is removed, the synthetic resin layer may correspond to the base layer 111-1. The synthetic resin layer may be a polyimide-based resin layer, and its material is not particularly limited. In addition, the base layer 111-1 may include a glass substrate, a metal substrate, an organic/inorganic composite material substrate, or the like.

The circuit element layer 112-1 may include at least one insulating layer and at least one circuit element. Hereinafter, the insulating layer included in the circuit element layer 112-1 will be referred to as an intermediate insulating layer. The intermediate insulating layer may include at least one inorganic layer and/or at least one organic layer. The circuit element may include a signal line, a pixel driving circuit, and the like. The circuit element layer 112-1 may be formed through a process of forming an insulating layer, a semiconductor layer, and a conductive layer through coating, deposition, or the like, and a process of patterning the insulating layer, the semiconductor layer, and the conductive layer through photolithography.

The display element layer 113-1 may include at least one light-emitting element. The display element layer 113-1 may include OLEDs as light-emitting elements. The display element layer 113-1 may further include an organic layer, such as a pixel defining layer.

In an embodiment of the disclosure, the display 110-1 may further include an upper insulating layer on the display element layer 113-1. The upper insulating layer may include a thin film encapsulation layer that seals the display element layer 113-1. The upper insulating layer may further include functional layers, such as a capping layer, an anti-reflection layer, or a refractive index control layer.

The upper polarizing plate 114-1 may transmit light of a particular polarization and absorb light of other polarizations. Accordingly, light polarized in a particular direction may be incident on the polarization control array 120.

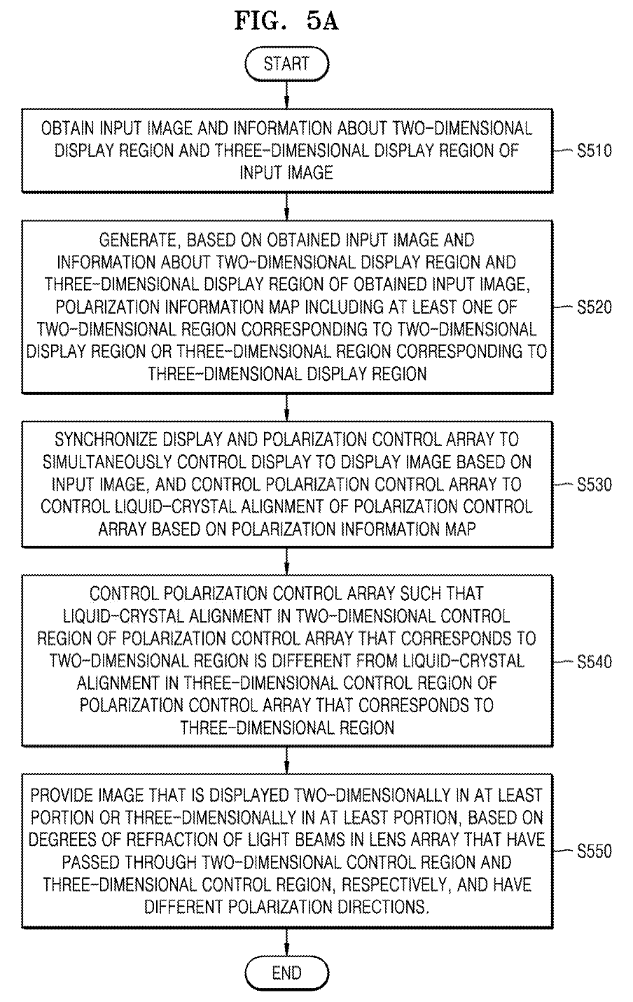

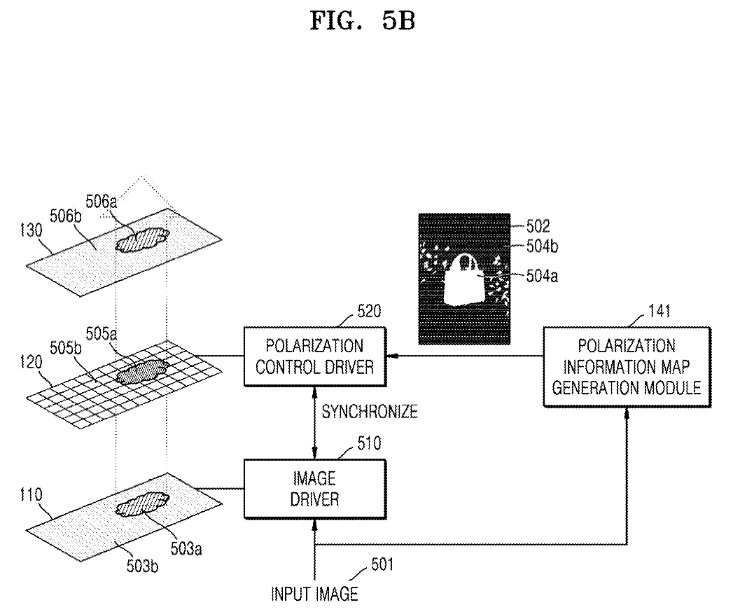

FIG. 5A is a flowchart for describing operations of an electronic device according to an embodiment of the disclosure.

In operation S510 of FIG. 5A, the electronic device 1000 according to an embodiment of the disclosure may obtain an input image and information about a two-dimensional display region and a three-dimensional display region of the input image.

In operation S520 of FIG. 5A, the electronic device 1000 according to an embodiment of the disclosure may generate, based on the obtained input image and the information about the two-dimensional display region and the three-dimensional display region of the obtained input image, a polarization information map including at least one of a two-dimensional region corresponding to the two-dimensional display region or a three-dimensional region corresponding to the three-dimensional display region.

In operation S530 of FIG. 5A, the electronic device 1000 according to an embodiment of the disclosure may synchronize the display 110 and the polarization control array 120 to simultaneously control the display 110 to display an image based on the input image, and control the polarization control array 120 to control the liquid-crystal alignment of the polarization control array 120 based on the polarization information map.

In operation S540 of FIG. 5A, the electronic device 1000 according to an embodiment of the disclosure may control the polarization control array 120 such that a first liquid-crystal alignment in the two-dimensional control region of the polarization control array 120 that corresponds to the two-dimensional region is different from a second liquid-crystal alignment in the three-dimensional control region of the polarization control array 120 that corresponds to the three-dimensional region.

In operation S550 of FIG. 5A, the electronic device 1000 according to an embodiment of the disclosure may provide an image that is displayed two-dimensionally in at least a portion or three-dimensionally in at least a portion, based on degrees of refraction of light beams in the lens array 130 after passing through the two-dimensional control region and the three-dimensional control region, respectively, each of the light beams having a polarization direction distinct from that of another light beam.

Hereinafter, the operation of the electronic device 1000 in each operation will be described in detail with reference to FIG. 5B.

FIG. 5B is a diagram for describing operations of an electronic device according to an embodiment of the disclosure.

Referring to FIG. 5B, in an embodiment of the disclosure, the electronic device 1000 may include the display 110, an image driver 510 configured to control the display 110, the polarization control array 120, a polarization control driver 520 configured to control the polarization control array 120, the lens array 130, and the polarization information map generation module 141. According to an embodiment, the image driver 510 and the polarization control driver 520 may be integrated as part of the processor 150 or may be components within the electronic device 1000 that are separate from the processor 150.

In an embodiment of the disclosure, the image driver 510 may receive (or obtain) an input image 501. The polarization information map generation module 141 may receive (or obtain) the input image 501.

In an embodiment of the disclosure, the display 110 may include a first display region for displaying an image to be provided to a user’s left eye, and a second display region for displaying an image to be provided to the user’s right eye.

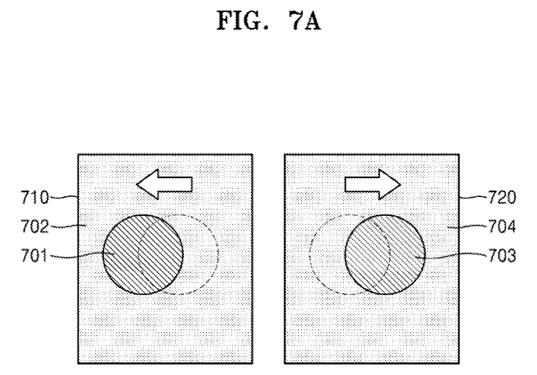

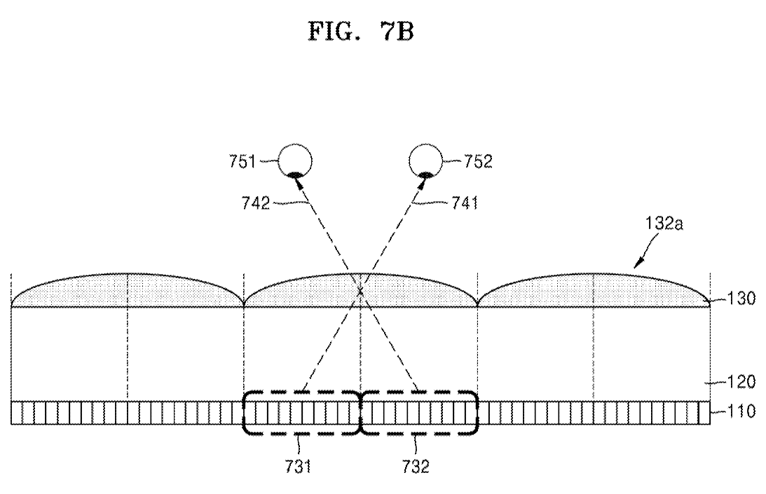

In an embodiment of the disclosure, the received input image 501 may include a first input image to be displayed in the first display region, and a second input image to be displayed in the second display region. That is, the image driver 510 and the polarization information map generation module 141 may separately obtain the first input image and the second input image. The first input image and the second input image will be described in detail with reference to FIGS. 7A to 9.

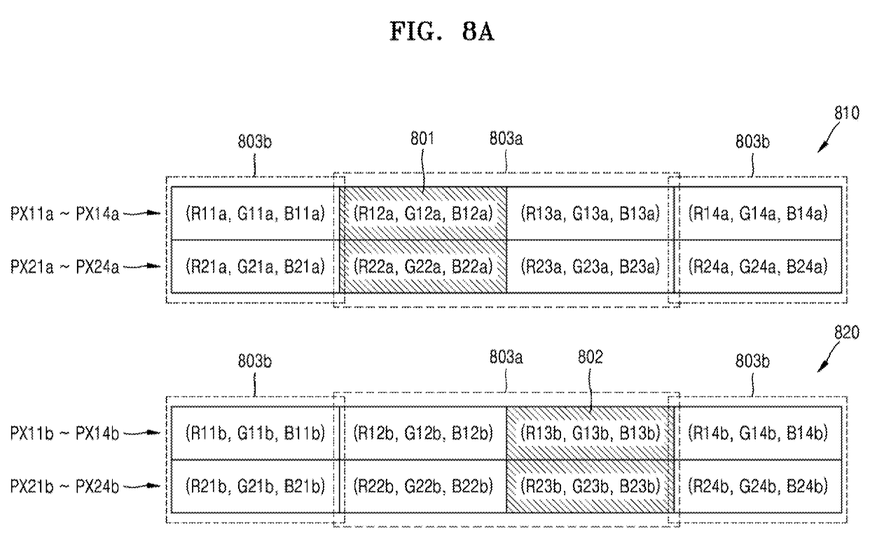

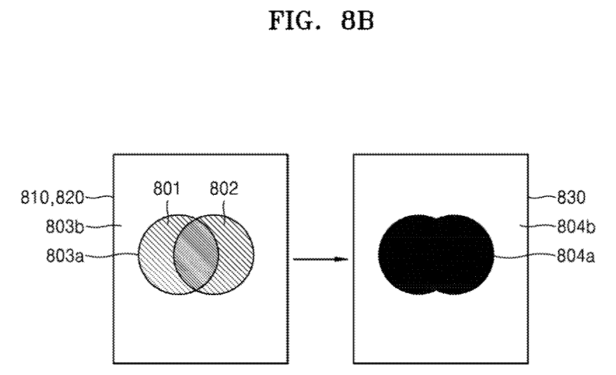

In an embodiment of the disclosure, the received input image 501 may include information about a region to be displayed in two dimensions (also referred to as a two-dimensional display region) and a region to be displayed in three dimensions (also referred to as a three-dimensional display region). That is, the image driver 510 and the polarization information map generation module 141 may obtain information about the two-dimensional display region and the three-dimensional display region of the input image 501. For example, the information about the two-dimensional display region and the three-dimensional display region of the input image 501 may include information about display of the input image 501 that is directly received by the electronic device 1000, and a two-dimensional display region and a three-dimensional display region that are identified (or determined) based on the received information about the display of the input image 501. For example, the information about the display of the input image 501 that is directly received by the electronic device 1000 may include pixel values of the first input image and pixel values of the second input image. The obtaining of the information about the two-dimensional display region and the three-dimensional display region of the input image 501 may include identifying the two-dimensional display region based on the corresponding pixel values of the first input image and the second input image being equal to each other, and identifying the three-dimensional display region based on the corresponding pixel values of the first input image and the second input image being different from each other. The identifying of the two-dimensional display region and the three-dimensional display region of the input image 501 based on pixel values will be described in detail with reference to FIGS. 8A and 8B.

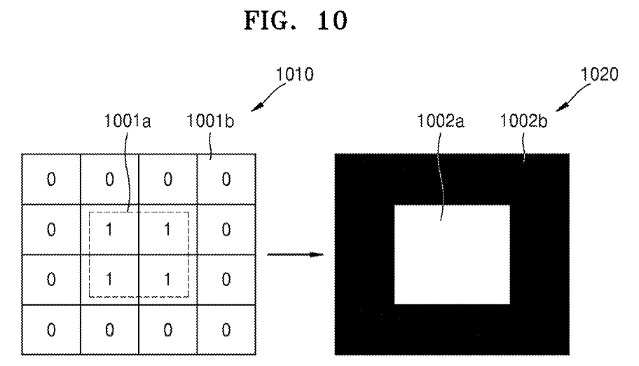

For example, the information about the display of the input image 501 that is directly received by the electronic device 1000 may include image data including a first label value assigned to pixels corresponding to the two-dimensional display region, and a second label value assigned to pixels corresponding to the three-dimensional display region in the input image 501. The obtaining of the information about the two-dimensional display region and the three-dimensional display region of the input image 501 may include receiving data regarding a first label value assigned to pixels corresponding to the two-dimensional display region, and a second label value assigned to pixels corresponding to the three-dimensional display region in the input image 501. The identifying of the two-dimensional display region and the three-dimensional display region of the input image 501 based on the image data including the first label value and the second label value will be described in detail with reference to FIG. 10.

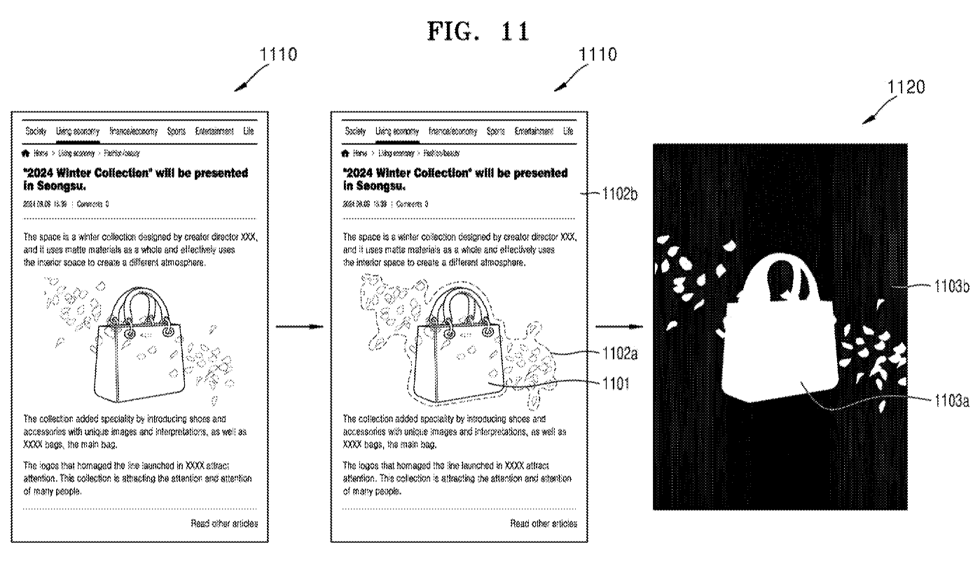

In an embodiment of the disclosure, the received input image 501 may not include information about the display of the input image 501. The electronic device 1000 may identify an image (or visual content) or text (or text content) from the received input image 501 and transmit information about an identified image region and/or an identified text region to the image driver 510 and the polarization information map generation module 141. That is, the image driver 510 and the polarization information map generation module 141 may obtain information about the image region and/or the text region identified from the input image 501. For example, the information about the two-dimensional display region and the three-dimensional display region of the input image 501 may include information about an image region and/or a text region identified from the input image 501, and a two-dimensional display region and a three-dimensional display region that are identified (or determined) based on the information about the identified image region and/or the identified text region. The obtaining of the information about the two-dimensional display region and the three-dimensional display region of the input image 501 may include identifying an image (or visual content) in the input image 501, and identifying a three-dimensional display region based on the identified image (or the identified visual content) in the input image 501. For example, the polarization information map generation module 141 may determine to display the identified image region in three dimensions and to display the remaining region in two dimensions. The identifying of an image or text from the received input image 501 will be described in detail with reference to FIG. 11.

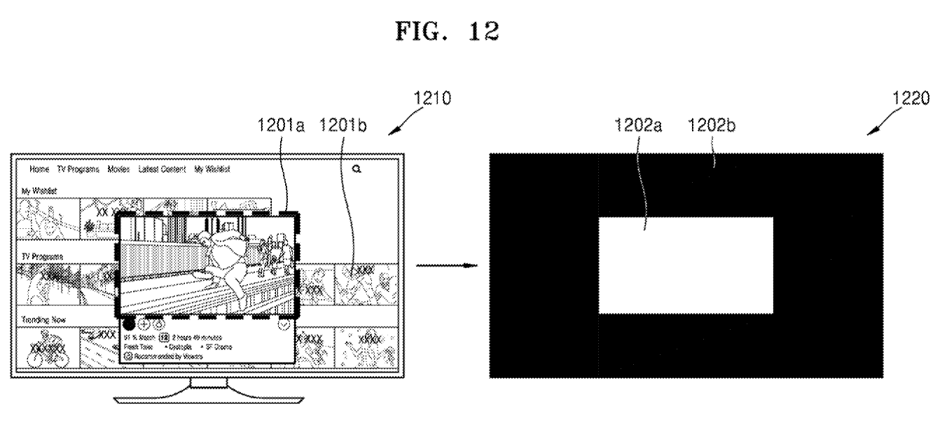

In an embodiment of the disclosure, the received input image 501 may include information about a preset three-dimensional display region. That is, the image driver 510 and the polarization information map generation module 141 may obtain the information about the preset three-dimensional display region. For example, the information about the two-dimensional display region and the three-dimensional display region of the input image 501 may include information about a preset three-dimensional display region, and a two-dimensional display region and a three-dimensional display region that are identified (or determined) based on the information about the preset three-dimensional display region. The obtaining of the information about the two-dimensional display region and the three-dimensional display region of the input image 501 may include obtaining information about a preset three-dimensional display region from the input image, and identifying the three-dimensional display region based on the information about the preset three-dimensional display region. The information about the preset three-dimensional display region will be described in detail with reference to FIG. 12.

In an embodiment of the disclosure, the polarization information map generation module 141 may generate a polarization information map 502 based on the received input image 501. For example, based on the received input image 501, the polarization information map generation module 141 may identify (or determine) a region 503a to be displayed in three dimensions (or a three-dimensional display region) and a region 503b to be displayed in two dimensions (or a two-dimensional display region). Accordingly, the electronic device 1000 may obtain information about the region 503a of the input image 501 to be displayed in three dimensions and the region 503b of the input image 501 to be displayed in two dimensions. The electronic device 1000 may generate the polarization information map 502 based on the input image 501 and the information about the region 503a of the input image 501 to be displayed in three dimensions and the region 503b of the input image 501 to be displayed in two dimensions. In addition, in an embodiment of the disclosure, the region 503a of the input image 501 to be displayed in three dimensions and the region 503b of the input image 501 to be displayed in two dimensions may be identified based on the input image 501 by an external module, and the polarization information map generation module 141 may receive, from the external module, information about the identified region 503a to be displayed in three dimensions and the identified region 503b to be displayed in two dimensions.

The polarization information map generation module 141 may determine a three-dimensional region 504a of the polarization information map 502 based on the region 503a to be displayed in three dimensions, and determine a two-dimensional region 504b of the polarization information map 502 based on the region 503b to be displayed in two dimensions. The polarization information map generation module 141 may transmit the generated polarization information map 502 to the polarization control driver 520. The identifying of the region 503a of the input image 501 to be displayed in three dimensions and the region 503b of the input image 501 to be displayed in two dimensions, and the determining of the three-dimensional region 504a and the two-dimensional region 504b of the polarization information map 502 will be described in detail with reference to FIGS. 7A to 12.

In an embodiment of the disclosure, based on the received polarization information map 502, the polarization control array 120 may control an alignment direction of liquid-crystal molecules in each cell of the polarization control array 120. For example, within the polarization control array 120, a three-dimensional control region 505a corresponding to the three-dimensional region 504a of the polarization information map 502 and a two-dimensional control region 505b corresponding to the two-dimensional region 504b of the polarization information map 502 may be controlled to have different alignment directions.

In an embodiment of the disclosure, among light beams that have passed through the polarization control array 120, a light beam that has passed through the three-dimensional control region 505a of the polarization control array 120 and a light beam that has passed through the two-dimensional control region 505b may have different polarization directions. Accordingly, in the lens array 130, a lens on which light that has passed through the two-dimensional control region 505b is incident may have a refractive index different from that of a lens on which light that has passed through the three-dimensional control region 505a is incident. Light that has passed through the two-dimensional control region 505b may not be refracted in the lens array 130 (e.g., region 506b of the lens array 130) and thus may provide a two-dimensional image to the user. Light that has passed through the three-dimensional control region 505a may be refracted in the lens array 130 (e.g., region 506a of the lens array 130), and thus provide a three-dimensional image to the user.

In an embodiment of the disclosure, the image driver 510 and the polarization control driver 520 may be synchronized. An operation, performed by the polarization control driver 520, of controlling the polarization control array 120 to control the liquid-crystal alignment of the polarization control array 120 based on the received polarization information map 502 may be performed simultaneously with an operation, performed by the image driver 510, of controlling the display 110 to display an output image based on the received input image 501. The electronic device 1000 may simultaneously perform controlling the liquid-crystal alignment of the polarization control array 120 based on the received polarization information map 502, and displaying, on the display 110, an output image based on the received input image 501. For example, when the input image 501 is a dynamic image including images of a plurality of frames, the image driver 510 and the polarization control driver 520 may be synchronized each time the image of each frame is displayed.

In an embodiment of the disclosure, the electronic device 1000 may synchronize an operation of controlling the image driver 510 to input, to the display 110, image data (or visual data) obtained from the input image 501, and an operation of controlling the polarization control driver 520 to input the polarization information map 502 to the polarization control array 120. In the disclosure, “controlling the image driver 510 to input image data obtained from the input image 501 to the display 110” may mean controlling the image driver 510 to transmit, to the display 110, signals generated based on the image data, such as control signals, scan signals, or data signals, in order to output a particular image via the display 110. In the disclosure, “controlling the polarization control driver 520 to input the polarization information map 502 to the polarization control array 120” may mean controlling the polarization control driver 520 to transmit, to the polarization control array 120, signals generated based on the polarization information map 502, such as control signals, scan signals, or data signals, in order to control a liquid-crystal alignment in the polarization control array 120.

According to an embodiment of the disclosure, while the display 110 displays an output image of a particular frame, the polarization control array 120 may simultaneously have a liquid-crystal alignment based on the polarization information map 502 corresponding to the particular frame. Accordingly, while light forming a still image of a particular frame provided via the display 110 passes through the polarization control array 120, the polarization direction of the light may be controlled in accordance with the polarization information map 502 corresponding to the particular frame. Among light beams provided via the display 110, the light beams that pass through the three-dimensional control region 505a of the polarization control array 120 may provide a three-dimensional image to the user, and the light beams that pass through the two-dimensional control region 505b may provide a two-dimensional image to the user. The accuracy of the two-dimensional representation and the three-dimensional representation of the image provided to the user may be improved. Accordingly, the electronic device may provide an image with improved display accuracy and display reliability.

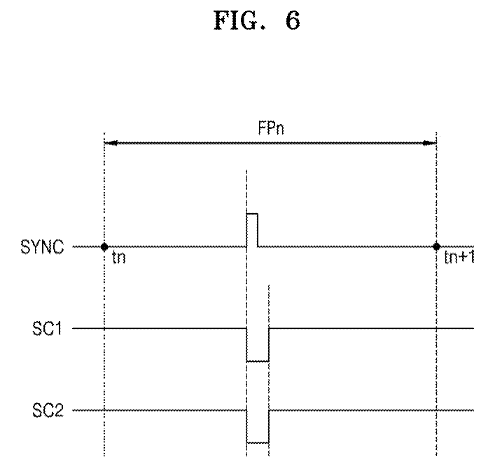

FIG. 6 is a timing diagram for describing operations of an electronic device according to an embodiment of the disclosure. FIG. 6 illustrates a timing diagram corresponding to one frame period FPn (e.g., an n-th frame period FPn).

Referring to FIG. 6, in an embodiment of the disclosure, the electronic device 1000 may synchronously perform an image display operation of the display 110 and a liquid-crystal alignment control operation of the polarization control array 120. The electronic device 1000 may synchronously perform an operation of controlling the display 110 to display an image of a particular frame, and an operation of controlling the polarization control array 120 to control a liquid-crystal alignment based on a polarization information map corresponding to the particular frame.

After identifying, in the received input image, a region to be displayed in two dimensions (or a two-dimensional region) and a region to be displayed in three dimensions (or a three-dimensional region), based on the input image, and generating a polarization information map based the identified regions, the electronic device 1000 may activate a synchronization signal SYNC. Based on the activated synchronization signal SYNC, the electronic device 1000 may start an image display operation of the display 110 and a liquid-crystal alignment control operation of the polarization control array 120. For example, the electronic device 1000 may receive an input image for a frame corresponding to a time point tn at which the frame period FP starts.

Although FIG. 6 illustrates an example in which the synchronization signal SYNC is activated at a high level and deactivated at a low level, the disclosure is not limited thereto, and the synchronization signal SYNC may also be activated at a low level and deactivated at a high level.

The electronic device 1000 may start the image display operation of the display 110 based on the synchronization signal SYNC. For example, the electronic device 1000 may activate a scan signal for the display 110 in accordance with the synchronization signal SYNC (e.g., in synchronization with the synchronization signal SYNC). In the disclosure, a scan signal for the display 110 is referred to as a first scan signal SC1. The first scan signal SC1 illustrated in FIG. 6 may be a scan signal for a first pixel row to be scanned in the display 110. The first scan signal SC1 may be activated based on the synchronization signal SYNC. The electronic device 1000 may activate and input the first scan signal SC1 to the display 110 in synchronization with the synchronization signal SYNC.

Although FIG. 6 illustrates an example in which the first scan signal SC1 is activated at a low level and deactivated at a high level, the disclosure is not limited thereto, and the first scan signal SC1 may also be activated at a high level and deactivated at a low level.

The electronic device 1000 may start the liquid-crystal alignment control operation of the polarization control array 120 in synchronization with the synchronization signal SYNC. For example, the electronic device 1000 may activate a scan signal for the polarization control array 120 in accordance with the synchronization signal SYNC (e.g., in synchronization with the synchronization signal SYNC). In the disclosure, a scan signal for the polarization control array 120 is referred to as a second scan signal SC2. The second scan signal SC2 illustrated in FIG. 6 may be a scan signal for a first cell to be scanned in the polarization control array 120. The second scan signal SC2 may be activated based on the synchronization signal SYNC. The electronic device 1000 may activate and input the second scan signal SC2 to the polarization control array 120 in synchronization with the synchronization signal SYNC.

Although FIG. 6 illustrates an example in which the second scan signal SC2 is activated at a low level and deactivated at a high level, the disclosure is not limited thereto, and the second scan signal SC2 may also be activated at a high level and deactivated at a low level.

In an embodiment of the disclosure, the first scan signal SC1 for the display 110 and the second scan signal SC2 for the polarization control array 120 may be activated simultaneously. For example, the first scan signal SC1 and the second scan signal SC2 may be activated when the synchronization signal SYNC is activated. For example, the first scan signal SC1 and the second scan signal SC2 may also be activated after a short time period from a time point at which the synchronization signal SYNC is activated.

According to an embodiment of the disclosure, the accuracy of the two-dimensional representation and the three-dimensional representation of an image provided to a user may be improved because the electronic device 1000 displays an image of a particular frame via the display 110 while the polarization control array 120 simultaneously has a liquid-crystal alignment corresponding to the polarization information map 502 for the particular frame. While an image for a particular frame is being displayed, the polarization control array 120 may be prevented from being aligned based on the polarization information map 502 for a different frame. Accordingly, the electronic device 1000 may provide an image with improved display accuracy and display reliability.

FIG. 7A is a diagram for describing a plurality of input images corresponding to a plurality of display regions, respectively, according to an embodiment of the disclosure.

In an embodiment of the disclosure, the display 110 may receive a first input image 710 and a second input image 720. The electronic device 1000 may display the first input image 710 and the second input image 720 via the display 110, such that the first input image 710 corresponds to the right eye, and the second input image 720 corresponds to the left eye. In an embodiment of the disclosure, the electronic device 1000 may generate a polarization information map based on the first input image 710 and the second input image 720.

In an embodiment of the disclosure, the first input image 710 may include at least one first input region 701 and at least one second input region 702. Although FIG. 7A illustrates an example in which the first input image 710 includes one first input region 701 and one second input region 702 surrounding the first input region 701, embodiments of the disclosure are not limited thereto. For example, a plurality of first input regions 701 and/or a plurality of second input regions 702 may be provided. For example, the first input region 701 may surround the second input region 702. The first input region 701 may be referred to as a left-eye image region.

In an embodiment of the disclosure, the second input image 720 may include at least one third input region 703 and at least one fourth input region 704. Although FIG. 7A illustrates an example in which the second input image 720 includes one third input region 703 and one fourth input region 704 surrounding the third input region 703, embodiments of the disclosure are not limited thereto. For example, a plurality of third input regions 703 and/or a plurality of fourth input regions 704 may be provided. For example, the third input region 703 may surround the fourth input region 704. The third input region 703 may be referred to as a right-eye image region.

In an embodiment of the disclosure, the first input region 701 may include at least one first object. In the disclosure, an ‘object’ may refer to a particular item within an image and may be classified by class. For example, a person, an animal, a thing, a natural object, a building, or the like within an image may be referred to as an object. In an embodiment of the disclosure, an object may include a certain region of a certain item. For example, an object may include a person’s face. FIG. 7A illustrates an example in which the first input region 701 includes one first object corresponding to a circular shape. Hereinafter, the first input region 701 and the first object will be described using the same reference numeral. Although FIG. 7A illustrates an example in which the first input region 701 includes one first object 701, embodiments of the disclosure are not limited thereto, and a plurality of objects may also be included in the first input region 701.

In an embodiment of the disclosure, the third input region 703 may include at least one second object. FIG. 7A illustrates an example in which the third input region 703 includes one second object corresponding to a circular shape. Hereinafter, the third input region 703 and the second object will be described using the same reference numeral. Although FIG. 7A illustrates an example in which the third input region 703 includes one second object 703, embodiments of the disclosure are not limited thereto, and a plurality of objects may also be included in the third input region 703.

In an embodiment of the disclosure, the first object 701 and the second object 703 may represent the same object. In addition, in a case in which a plurality of first objects are included in the first input region 701 and a plurality of second objects are included in the third input region 703, the plurality of first objects may represent the same objects as the plurality of second objects, respectively.

In an embodiment of the disclosure, the second input region 702 may be a region corresponding to a background within the first input image 710. For example, the second input region 702 may include a background surrounding at least one first object 701 included in the first input region 701. In an embodiment of the disclosure, the second input region 702 may include at least one other object around the first object 701.

In an embodiment of the disclosure, the fourth input region 704 may be a region corresponding to a background within the second input image 720. For example, the fourth input region 704 may include a background surrounding at least one second object 703 included in the third input region 703. In an embodiment of the disclosure, the fourth input region 704 may include at least one other object around the second object 703.

In an embodiment of the disclosure, the position of the first object 701 within the first input image 710 and the position of the second object 703 within the second input image 720 may be different from each other. When the first input image 710 is compared with the second input image 720, the first object 701 within the first input image 710 may be shifted to the left relative to the position of the object represented by the first object 701 and the second object 703. The second object 703 within the second input image 720 may be shifted to the right relative to the position of the object represented by the first object 701 and the second object 703.

In an embodiment of the disclosure, the user may perceive, through his/her right eye, the first object 701 that is relatively shifted to the left within the first input image 710, and perceive, through his/her left eye, the second object 703 that is relatively shifted to the right within the second input image 720. Accordingly, the user may perceive a three-dimensional effect of the object represented by the first object 701 and the second object 703 through binocular disparity. For example, the user may perceive the object represented by the first object 701 and the second object 703, as being located closer than the display 110. However, the disclosure is not limited thereto, and the object represented by the first object 701 and the second object 703 may also be provided such that the user perceives the object as being located farther away.

In an embodiment of the disclosure, at least one third object may be included in the second input region 702, and at least one fourth object may be included in the fourth input region 704. The at least one third object may represent the same object as the at least one fourth object, respectively. In an embodiment of the disclosure, the position of the third object within the first input image 710 and the position of the fourth object within the second input image 720 may be identical to each other. A position of the third object perceived by the user through his/her right eye and a position of the fourth object perceived by the user through his/her left eye may be identical to each other. Accordingly, the user may perceive the object represented by the third object and the fourth object, as being located on a screen (e.g., a reference plane) of the display 110. Alternatively, the user may perceive the third object and the fourth object as having a depth value of “0”.

FIG. 7B is a diagram for describing an operation, performed by an electronic device, of generating a three-dimensional image, according to an embodiment of the disclosure.

In an embodiment of the disclosure, the electronic device 1000 may include the display 110, the lens array 130, and the polarization control array 120 arranged between the display 110 and the lens array 130.

In an embodiment of the disclosure, the lens array 130 may include a plurality of lenses 132a. Each of the plurality of lenses 132a may include two view regions. A “view region” may be a region that refracts an input image, which is provided to the region via the display 110, such that the input image is provided to a user as a corresponding view. In addition, according to an embodiment of the disclosure, in each of the lenses 132a, the two view regions may not be clearly distinguished from each other, and a region in which a first input image 741 is refracted may overlap, at least in part, with a region in which a second input image 742 is refracted.

In an embodiment of the disclosure, the display 110 may include a first display region 731 and a second display region 732 that correspond to two view regions, respectively. First display regions 731 and second display regions 732 may be included alternately in the display 110. Each of the first display region 731 and the second display region 732 may include a plurality of pixels. In addition, in an embodiment of the disclosure, the display 110 may include n display regions, wherein n may be an integer of 3 or greater.

In an embodiment of the disclosure, the first input image 741 may be displayed in the first display region 731. The first input image 741, which has been refracted by a lens 132a included in the lens array 130 after passing through the polarization control array 120, may be provided to a right eye 752 of a user.

In an embodiment of the disclosure, the second input image 742 may be displayed in the second display region 732. The second input image 742, which has been refracted by a lens 132a included in the lens array 130 after passing through the polarization control array 120, may be provided to a left eye 751 of the user.

FIG. 8A is a diagram for describing an operation, performed by an electronic device, of generating a polarization information map, according to an embodiment of the disclosure. FIG. 8B is a diagram for describing an operation, performed by an electronic device, of generating a polarization information map, according to an embodiment of the disclosure.

Referring to FIGS. 8A and 8B, in an embodiment of the disclosure, information about a two-dimensional display region and a three-dimensional display region of an input image may include information about display of the input image that is directly received by the electronic device 1000, and a two-dimensional display region and a three-dimensional display region that are identified (or determined) based on the received information about the display of the input image.

In an embodiment of the disclosure, the electronic device 1000 may receive pixel value information about a first input image 810 and pixel value information about a second input image 820. That is, the information about the display of the input image that is directly received by the electronic device 1000 may include the pixel value information about the first input image 810, and the pixel value information about the second input image 820. The electronic device 1000 may generate a polarization information map based on the pixel value information about the first input image 810, and the pixel value information about the second input image 820.

In the disclosure, ‘pixel value information’ may refer to color information and brightness information to be output via pixels of the display 110. The pixel value information about the first input image 810 may include information about pixel values of respective pixels PX11a to PX14a and PX21a to PX24a that display a first display region, among the pixels of the display 110. The pixel value information about the second input image 820 may include information about pixel values of respective pixels PX11b to PX14b and PX21b to PX24b that display a second display region, among the pixels of the display 110.

In an embodiment of the disclosure, the pixel value information about the first input image 810 may include color intensity information about each of a plurality of pixels PX11a to PX14a and PX21a to PX24a included in the first input image 810. For example, the first input image 810 may be a color image. For example, the first input image 810 may be composed of red, green, and blue channels. Color intensity information about any one pixel at a particular position among the plurality of pixels PX11a to PX14a and PX21a to PX24a included in the first input image 810 may include a red intensity, a green intensity, and a blue intensity. In the disclosure, red intensities, green intensities, and blue intensities included in the pixel value information about the first input image 810 may be defined as first red intensities, first green intensities, and first blue intensities, respectively. Each of the first red intensities, the first green intensities, and the first blue intensities may be expressed as an integer between 0 and 255.

In an embodiment of the disclosure, the pixel value information about the second input image 820 may include color intensity information about each of a plurality of pixels PX11b to PX 14b and PX21b to PX24b included in the second input image 820. For example, the second input image 820 may be a color image. For example, the second input image 820 may be composed of red, green, and blue channels. Color intensity information about any one pixel at a particular position among the plurality of pixels PX11b to PX14b and PX21b to PX24b included in the second input image 820 may include a red intensity, a green intensity, and a blue intensity. In the disclosure, red intensities, green intensities, and blue intensities included in the pixel value information about the second input image 820 may be defined as second red intensities, second green intensities, and second blue intensities, respectively. Each of the second red intensities, the second green intensities, and the second blue intensities may be expressed as an integer between 0 and 255.

FIG. 8A illustrates an example in which the first input image 810 includes eight pixels PX11a to PX14a and PX21a to PX24a in four columns and two rows, and the second input image 820 includes eight pixels PX11b to PX14b and PX21b to PX24b in four columns and two rows. The pixel value information about the first input image 810 may include, respectively for the eight pixels PX11a to PX14a and PX21a to PX24a, “first red intensities R11a to R14a and R21a to R24a, first green intensities G11a to G14a and G21a to G24a, and first blue intensities B11a to B14a and B21a to B24a”. The pixel value information about the second input image 820 may include, respectively for the eight pixels PX11b to PX14b and PX21b to PX24b, “second red intensities R11b to R14b and R21b to R24b, second green intensities G11b to G14b and G21b to R24b, and second blue intensities B11b to B14b and B21b to B24b”.

In an embodiment of the disclosure, the polarization information map generation module 141 may identify a region to be displayed in two dimensions (hereinafter, referred to as a two-dimensional display region 803b) and a region to be displayed in three dimensions (also referred to as a three-dimensional display region 803a), by comparing pixel value information about the plurality of pixels PX11a to PX14a and PX21a to PX24a included in the first input image 810 with pixel value information about the plurality of pixels PX11b to PX14b and PX21b to PX24b included in the second input image 820, respectively.

For example, the polarization information map generation module 141 may identify, as the two-dimensional display region 803b, a region corresponding to the pixels PX12a, PX13a, PX22a, PX23a, PX12b, PX13b, PX22b, and PX23b for which the pixel value information about the first input image 810 and the pixel value information about the second input image 820 are different from each other. For example, the polarization information map generation module 141 may identify, as the two-dimensional display region 803b, a region corresponding to the pixels PX11a, PX14a, PX21a, PX24a, PX11b, PX14b, PX21b, and PX24b for which the pixel value information about the first input image 810 and the pixel value information about the second input image 820 are identical to each other.

In an embodiment of the disclosure, the electronic device 1000 may provide a display image in which the corresponding first object 801 and second object 802 are displayed in three dimensions, and a background, excluding the corresponding first object 801 and second object 802, is displayed in two dimensions.

FIG. 8A illustrates an example of displaying the first object 801 (or a part of the first object) in the pixels PX12a and PX22a at the first row and the second column and at the second row and the second column of the first input image 810, and displaying the background in the remaining pixels PX11a, PX13a, PX14a, PX21a, PX23a, and PX24a of the first input image 810. FIG. 8A illustrates an example of displaying the second object 802 (or a part of the second object) in the pixels PX13b and PX23b at the first row and the third column and at the second row and the third column of the second input image 820, and displaying a background in the remaining pixels PX11b, PX12b, PX14b, PX21b, PX22b, and PX24b of the second input image 820.

The electronic device 1000 may identify that the pixels PX12a and PX22a at the first row and the second column and at the second row and the second column of the first input image 810, in which the first object 801 is displayed, and the pixels PX12b and PX22b at the first row and the second column and at the second row and the second column of the second input image 820, in which the background is displayed, have different pixel value information at the corresponding positions.

The electronic device 1000 may identify that the pixels PX13a and PX23a at the first row and the third column and at the second row and the third column of the first input image 810, in which the background is displayed, and the pixels PX13b and PX23b at the first row and the third column and at the second row and the third column of the second input image 820, in which the second object 802 is displayed, have different pixel value information at the corresponding positions.

As illustrated in FIGS. 8A and 8B, the polarization information map generation module 141 may identify (or determine) a three-dimensional region 804a, based on the pixel value information at corresponding pixels between the first input image 810 and the second input image 820 being different. For example, the electronic device 1000 may identify (or determine), as the three-dimensional display region 803a, a region corresponding to the pixels PX12a, PX13a, PX22a, PX23a, PX12b, PX13b, PX22b, and PX23b at the first row and the second column, at the first row and the third column, at the second row and the second column, and at the second row and the third column of the first input image 810 and the second input image 820, which are identified as having different pixel value information, and determine, as the three-dimensional region 804a in a polarization information map 830, the region corresponding to the pixels identified as having different pixel value information.

The polarization information map generation module 141 may identify (or determine) a two-dimensional region 804b, based on pixel value information at corresponding pixels between the first input image 810 and the second input image 820 being identical. For example, the electronic device 1000 may identify that the pixels PX11a, PX14a, PX21a, PX24a, PX11b, PX14b, PX21b, and PX24b at the first row and the first column, at the first row and the fourth column, at the second row and the first column, and at the second row and the fourth column, in which the background is displayed in both the first input image 810 and the second input image 820, have identical pixel value information at corresponding positions. The electronic device 1000 may identify, as the two-dimensional display region 803b, a region corresponding to the pixels PX11a, PX14a, PX21a, PX24a, PX11b, PX14b, PX21b, and PX24b at the first row and the first column, at the first row and the fourth column, at the second row and the first column, and at the second row and the fourth column, which are identified (or determined) as having identical pixel value information, and determine, as the two-dimensional region 804b in the polarization information map 830, the region corresponding to the pixels identified as having identical pixel value information.

As illustrated in FIG. 8B, because the position at which the first object 801 is displayed in the first input image 810 is different from the position at which the second object 802 is displayed in the second input image 820, a region corresponding to pixels displaying the first object 801 and a region corresponding to pixels displaying the second object 802 may be identified as having different pixel values. Thus, the electronic device 1000 may identify, as the three-dimensional display region 803a, a union region of the region corresponding to the pixels displaying the first object 801 and the region corresponding to the pixels displaying the second object 802. The electronic device 1000 may determine, as the three-dimensional region 804a of the polarization information map 830, the union region of the region corresponding to the pixels displaying the first object 801 and the region corresponding to the pixels displaying the second object 802.

In addition, in an embodiment of the disclosure, although pixels at corresponding positions may display different parts of the first object 801 and the second object 802, the pixels may display parts having the same pixel value (e.g., color). In this case, a pixel value of the first input image 810 and a pixel value of the second input image 820 for pixels at corresponding positions may be identified as being equal to each other. Thus, to prevent a region to be displayed in three dimensions from being identified as a two-dimensional display region, the electronic device 1000 according to an embodiment of the disclosure may further include a module configured to identify an edge of an object. An edge of an object may be defined as a portion where pixel values change significantly, reflecting a large difference between the object and a background. The electronic device 1000 may identify an edge of the first object 801 in the first input image 810, and may define an interior of the edge of the first object 801, as a region in which the first object 801 is to be displayed. The electronic device 1000 may identify an edge of the second object 802 in the second input image 820, and may define an interior of the edge of the second object 802, as a region in which the second object 802 is to be displayed. Here, the three-dimensional display region 803a may be determined as a union region of a region in which the first object 801 is to be displayed and a region in which the second object 802 is to be displayed. The polarization information map generation module 141 may determine, as the three-dimensional region 804a of the polarization information map 830, the union region of the region in which the first object 801 is to be displayed and the region in which the second object 802 is to be displayed.

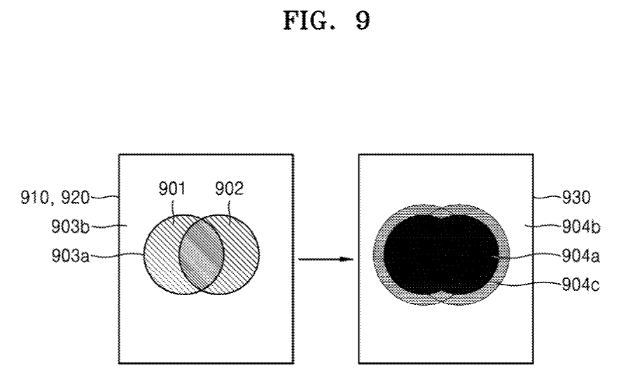

FIG. 9 is a diagram for describing an operation, performed by an electronic device, of generating a polarization information map, according to an embodiment of the disclosure.

Referring to FIG. 9, in an embodiment of the disclosure, a polarization information map 930 may include a two-dimensional region 904b, a three-dimensional region 904a, and a boundary region 904c. The boundary region 904c may be located between the two-dimensional region 904b and the three-dimensional region 904a. The polarization information map generation module may further set the boundary region 904c between the two-dimensional region 904b and the three-dimensional region 904a. For example, the boundary region 904c may be set to surround an entire boundary of the three-dimensional region 904a.

In an embodiment of the disclosure, a region to be displayed in two dimensions (hereinafter, referred to as a two-dimensional display region 903b) and a region to be displayed in three dimensions (hereinafter, referred to as a three-dimensional display region 903a) may be identified through a comparison of pixel values between corresponding pixels, as described above with reference to FIGS. 7A to 8B. However, the two-dimensional display region 903b and the three-dimensional display region 903a may also be identified through embodiments of the disclosure described below with reference to FIGS. 10 to 12.

In an embodiment of the disclosure, the electronic device 1000 may set, as the boundary region 904c, at least a part of a portion of the two-dimensional display region 903b or a portion of the three-dimensional display region 903a in a vicinity of a boundary between the two-dimensional display region 903b and the three-dimensional display region 903a.

For example, the electronic device 1000 (e.g., the polarization information map generation module 141) may set, as the boundary region 904c of the polarization information map 930, a region corresponding to a portion of the two-dimensional display region 903b in a vicinity of a boundary between the two-dimensional display region 903b and the three-dimensional display region 903a. The electronic device 1000 (e.g., the polarization information map generation module 141) may determine, as the two-dimensional region 904b of the polarization information map 930, a region corresponding to the remainder of the two-dimensional display region 903b excluding the portion of the two-dimensional display region 903b. The electronic device 1000 (e.g., the polarization information map generation module 141) may determine, as the three-dimensional region 904a of the polarization information map 930, a region corresponding to an entirety of the three-dimensional display region 903a.

For example, the electronic device 1000 (e.g., the polarization information map generation module 141) may set, as the boundary region 904c of the polarization information map 930, a region corresponding to a portion of the three-dimensional display region 903a in a vicinity of a boundary between the two-dimensional display region 903b and the three-dimensional display region 903a. The electronic device 1000 (e.g., the polarization information map generation module 141) may determine, as the three-dimensional region 904a of the polarization information map 930, a region corresponding to the remainder of the three-dimensional display region 903a excluding the portion of the three-dimensional display region 903a. The electronic device 1000 (e.g., the polarization information map generation module 141) may determine, as the two-dimensional region 904b of the polarization information map 930, a region corresponding to an entirety of the two-dimensional display region 903b.

For example, the electronic device 1000 (e.g., the polarization information map generation module 141) may set, as the boundary region 904c of the polarization information map 930, a region corresponding to a portion of the two-dimensional display region 903b and a portion of the three-dimensional display region 903a in a vicinity of a boundary between the two-dimensional display region 903b and the three-dimensional display region 903a. The electronic device 1000 (e.g., the polarization information map generation module 141) may determine, as the two-dimensional region 904b of the polarization information map 930, a region corresponding to the remainder of the two-dimensional display region 903b excluding the portion of the two-dimensional display region 903b. The electronic device 1000 (e.g., the polarization information map generation module 141) may determine, as the three-dimensional region 904a of the polarization information map 930, a region corresponding to the remainder of the three-dimensional display region 903a excluding the portion of the three-dimensional display region 903a.

In an embodiment of the disclosure, the electronic device 1000 may apply a first voltage to a three-dimensional control region of the polarization control array 120 corresponding to the three-dimensional region 904a of the polarization information map 930, while not applying a voltage to a two-dimensional control region of the polarization control array 120 corresponding to the two-dimensional region 904b of the polarization information map 930. The electronic device 1000 may apply a second voltage having an absolute value less than that of the first voltage, to a boundary control region of the polarization control array 120. The second voltage may have a value between zero and the first voltage, i.e., be an intermediate value of the first voltage.

In an embodiment of the disclosure, within the boundary control region of the polarization control array 120, the electronic device 1000 may apply the second voltage that gradually decreases from a region adjacent to the three-dimensional control region to a region adjacent to the two-dimensional control region.

A degree of change in a liquid-crystal alignment in the boundary control region of the polarization control array 120 may be less than a degree of change in a liquid-crystal alignment in the three-dimensional control region of the polarization control array 120. A degree of change (or rotation) in the polarization direction of light passing through the boundary control region may be less than a degree of change (or rotation) in the polarization direction of light passing through the three-dimensional control region. A degree of refraction of light passing through a lens after passing through the boundary control region may be less than a degree of refraction of light passing through the lens after passing through the three-dimensional control region. Light that has passed through the boundary control region may provide a user with an image in an intermediate state between two-dimensionality and three-dimensionality (e.g., an image with an incomplete stereoscopic effect or a semi-stereoscopic image), rather than a completely two-dimensional or completely three-dimensional image. For example, light that has passed through the boundary control region may be perceived by the user as if depth information is distorted or as if a first object 901 in a first input image 910 and a second object 902 in a second input image 920, which correspond to each other, are mixed, because ambiguous viewpoint information is delivered.

However, embodiments of the disclosure are not limited thereto, and in an embodiment of the disclosure, the electronic device 1000 may apply the first voltage to the two-dimensional control region of the polarization control array 120 corresponding to the two-dimensional region 904b of the polarization information map 930, while not applying a voltage to the three-dimensional control region of the polarization control array 120 corresponding to the three-dimensional region 904a of the polarization information map 930. The electronic device 1000 may apply the second voltage having an absolute value less than that of the first voltage, to the boundary control region of the polarization control array 120 that corresponds to the boundary region 904c of the polarization information map 930. The second voltage may have a value between zero and the first voltage, i.e., be an intermediate value of the first voltage.

According to an embodiment of the disclosure, by providing the boundary region 904c in the polarization information map 930, the electronic device 1000 may mitigate image distortion, ghosting, or crosstalk that may occur during off-axis viewing.

For example, a portion of the refracted first input image 910 may be provided to the user’s right eye. In detail, a partial image of the first input image 910, which is displayed in a vicinity of a boundary between the first display region and the second display region, may be refracted by the lens array 130, and then unintentionally provided to the user’s left eye. For example, a portion of the refracted second input image 920 may be provided to the user’s left eye. In detail, a partial image of the second input image 920, which is displayed in a vicinity of a boundary between the first display region and the second display region, may be refracted by the lens array 130, and then unintentionally provided to the user’s right eye. In this case, crosstalk may be perceived by the user due to the portion of the refracted first input image 910 being provided to the user’s left eye and the portion of the refracted second input image 920 being provided to the user’s left eye. According to an embodiment of the disclosure, by setting the boundary region 904c in the polarization information map 930, the electronic device 1000 may reduce the sharpness of a boundary of the three-dimensional region 904a, thereby mitigating the perception of crosstalk that may occur during off-axis viewing.

FIG. 10 is a diagram for describing an operation, performed by an electronic device, of generating a polarization information map, according to an embodiment of the disclosure.

Referring to FIG. 10, in an embodiment of the disclosure, information about a two-dimensional display region and a three-dimensional display region of an input image 1010 may include information about display of an input image 1010 that is directly received by the electronic device 1000, and a region to be displayed in two dimensions (hereinafter, referred to as a two-dimensional display region 1001b) and a region to be displayed in three dimensions (hereinafter, referred to as a three-dimensional display region 1001a) that are identified (or determined) based on the received information about the display of the input image 1010.

In an embodiment of the disclosure, the electronic device 1000 may receive image data (or visual data) including display information about the input image 1010. That is, the information about the display of the input image 1010 directly received by the electronic device 1000 may include the image data including the display information about the input image 1010. For example, the electronic device 1000 may receive image data including a first label value (e.g., ‘0’ in FIG. 10) assigned to pixels corresponding to the two-dimensional display region 1001b of the input image 1010, and a second label value (e.g., ‘1’ in FIG. 10) assigned to pixels corresponding to the three-dimensional display region 1001a of the input image 1010.

In an embodiment of the disclosure, the electronic device 1000 may generate a polarization information map 1020 based on the image data including the display information about the input image 1010. The electronic device 1000 (e.g., the polarization information map generation module 141) may identify (or determine), as a two-dimensional region 1002b of the polarization information map 1020, a region corresponding to pixels in which the first label value (e.g., ‘0’) is written. The electronic device 1000 (e.g., the polarization information map generation module 141) may identify (or determine), as a three-dimensional region 1002a of the polarization information map 1020, a region corresponding to pixels in which the second label value (e.g., ‘1’) is written.

In an embodiment of the disclosure, the input image 1010 may correspond to an image including a first input image to be displayed in a first display region, and a second input image to be displayed in a second display region.

For example, among the pixels in which the first label value (e.g., ‘0’) is written, pixels corresponding to each other in the first input image and the second input image may have the same pixel value. A region of the input image 1010 corresponding to the pixels in which the first label value (e.g., ‘0’) is written may be provided as the same image to the user’s left and right eyes, and thus provided to the user as a two-dimensional image.

For example, among the pixels in which the second label value (e.g., ‘1’) is written, pixels corresponding to each other in the first input image and the second input image may have different pixel values. A region of the input image 1010 corresponding to the pixels in which the second label value (e.g., ‘1’) is written may be provided as different images to the user’s left and right eyes, and thus provided to the user as a three-dimensional image.

However, in an embodiment of the disclosure, the input image 1010 received by the electronic device 1000 may not be an image including a first input image to be displayed in the first display region, and a second input image to be displayed in the second display region. For example, the input image 1010 may correspond to a single-view image. The electronic device 1000 may also receive image data including information about a region of the input image corresponding to a single-view image to be displayed in two dimensions, and a region of the input image to be displayed in three dimensions. In this case, the electronic device 1000 may directly generate a first input image to be displayed in the first display region, and a second input image to be displayed in the second display region, based on the input image 1010 corresponding to a single-view image and the image data.

FIG. 11 is a diagram for describing an operation, performed by an electronic device, of generating a polarization information map, according to an embodiment of the disclosure.

Referring to FIG. 11, in an embodiment of the disclosure, information about a two-dimensional display region and a three-dimensional display region of an input image may include information about display of an input image 1110 that is directly identified (or extracted or generated) by the electronic device 1000, and a region to be displayed in two dimensions (hereinafter, referred to as a two-dimensional display region 1102b) and a region to be displayed in three dimensions (hereinafter, referred to as a three-dimensional display region 1102a) that are identified (or determined) based on the information about the display of the received input image 1110. That is, the received input image 1110 may not include information about display of the input image 1110, and the electronic device 1000 may directly identify (or extract or generate) information about display of the input image 1110 based on the received input image 1110.

In an embodiment of the disclosure, the electronic device 1000 may obtain information about a region of the input image 1110 in which an image (or visual content) 1101 is displayed. In the disclosure, an “image” (or “visual content”) may be defined as a picture, a photograph, a graphic, an illustration, or a similar form of visual representation that includes visual elements other than text. An “image” (or “visual content”) may include information composed of points, lines, colors, shapes, and the like that are visually perceptible. For example, the electronic device 1000 may identify, from the input image 1110, a region in which the image 1101 is displayed. The electronic device 1000 may further include an image identification module for identifying the image 1101 within the input image 1110. In addition, the electronic device 1000 may preset the image 1101 to be identified. For example, the electronic device 1000 may identify only an image having a certain size or larger, or may identify only an image within a particular region.

In an embodiment of the disclosure, the electronic device 1000 may regard the region in which the image 1101 is displayed, as the three-dimensional display region 1102a. The electronic device 1000 may determine, as a three-dimensional region of a polarization information map 1120, a region corresponding to the region in which the image 1101 is displayed. In an embodiment of the disclosure, the electronic device 1000 may regard the remaining region excluding the region in which the image 1101 is displayed, as the two-dimensional display region 1102b. The electronic device 1000 may determine, as a two-dimensional region of the polarization information map 1120, a region corresponding to the remaining region in which the image 1101 is not displayed.

In an embodiment of the disclosure, the polarization information map generation module 141 may determine, as a three-dimensional region 1103a of the polarization information map 1120, a region corresponding to the region in which the image 1101 is displayed (i.e., the three-dimensional display region 1102a). The polarization information map generation module 141 may determine, as a two-dimensional region 1103b of the polarization information map 1120, a region corresponding to the remainder excluding the region in which the image 1101 is displayed (i.e., the two-dimensional display region 1102b).

In an embodiment of the disclosure, the electronic device 1000 may directly generate a first input image to be displayed in a first display region, and a second input image to be displayed in a second display region, such that the region in which the image 1101 is displayed is presented to the user in three dimensions. For example, the electronic device 1000 may generate the first input image 1110 and the second input image 1110 in which positions of the image 1101 are different from each other, such that the image 1101 in the input image 1110 may cause a parallax between the user’s left and right eyes and thus create a stereoscopic effect.

However, embodiments of the disclosure are not limited thereto. In an embodiment of the disclosure, the electronic device 1000 may obtain information about a region of the input image 1110 in which text is displayed. For example, the electronic device 1000 may identify a region of the input image 1110 in which text is displayed. The electronic device 1000 may regard the region in which the text is displayed, as a region to be displayed in two dimensions. The electronic device 1000 may determine a two-dimensional region of the polarization information map 1120, based on the region in which the text is displayed. The electronic device 1000 may regard the remaining region excluding the region in which the text is displayed, as a region to be displayed in three dimensions. The electronic device 1000 may determine a three-dimensional region of the polarization information map 1120, based on the remaining region in which text is not displayed.

FIG. 12 is a diagram for describing an operation, performed by an electronic device, of generating a polarization information map, according to an embodiment of the disclosure.

Referring to FIG. 12, in an embodiment of the disclosure, information about a two-dimensional display region and a three-dimensional display region of an input image may include information about display of an input image 1210 that is directly received by the electronic device 1000, and a region to be displayed in two dimensions (hereinafter, referred to as a two-dimensional display region 1201b) and a region to be displayed in three dimensions (hereinafter, referred to as a three-dimensional display region 1201a) that are identified (or determined) based on the received information about the display of the input image 1210.

In an embodiment of the disclosure, the electronic device 1000 may obtain image data (or visual data) including display information about the input image 1210. That is, the information about the display of the input image 1210 directly received by the electronic device 1000 may include the image data including the display information about the input image 1210. For example, the electronic device 1000 may obtain information about a preset three-dimensional display region 1201a in the input image 1210. For example, for a plurality of frames that display a continuous dynamic image, the three-dimensional display region 1201a may be preset at a fixed position.

For example, as illustrated in FIG. 12, the three-dimensional display region 1201a may be preset as a region in which an image is displayed via a pop-up window. For example, the input image 1210 may be a screen for providing a digital content service, and may display, via a pop-up window, a scene or a trailer of a movie selected by a user. However, FIG. 12 illustrates an example, and the three-dimensional display region 1201a may be set in various ways.

In an embodiment of the disclosure, the electronic device 1000 may determine, as a three-dimensional region 1202a of a polarization information map, a region corresponding to the preset three-dimensional display region 1201a. The electronic device 1000 may regard the remaining region excluding the preset three-dimensional display region 1201a, as the two-dimensional display region 1201b. The electronic device 1000 may determine, as a two-dimensional region 1202b of the polarization information map, a region corresponding to the remainder excluding the preset three-dimensional display region 1201a.

In an embodiment of the disclosure, the electronic device 1000 may obtain information about the three-dimensional display region 1201a that is preset by a user. The electronic device 1000 may provide a user interface that allows the user to select a region to be displayed in three dimensions. In an embodiment of the disclosure, the electronic device 1000 may obtain information about the three-dimensional display region 1201a that is preset by an image (or content) provider.

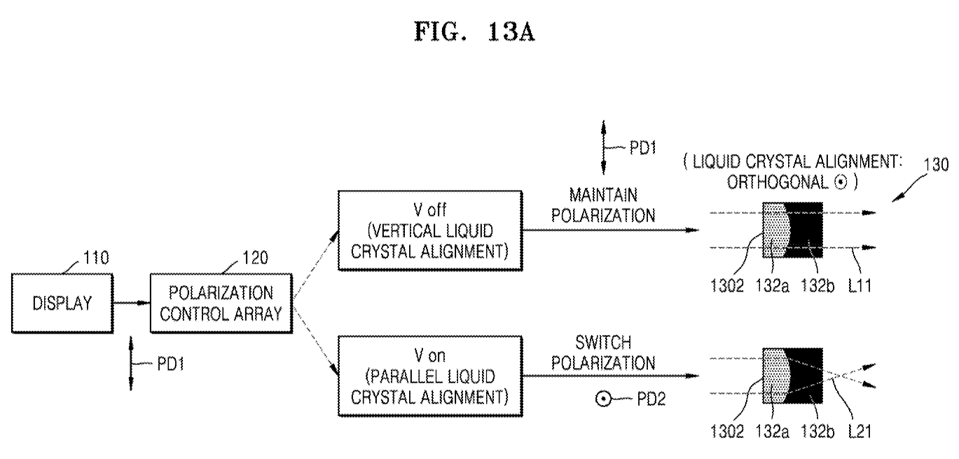

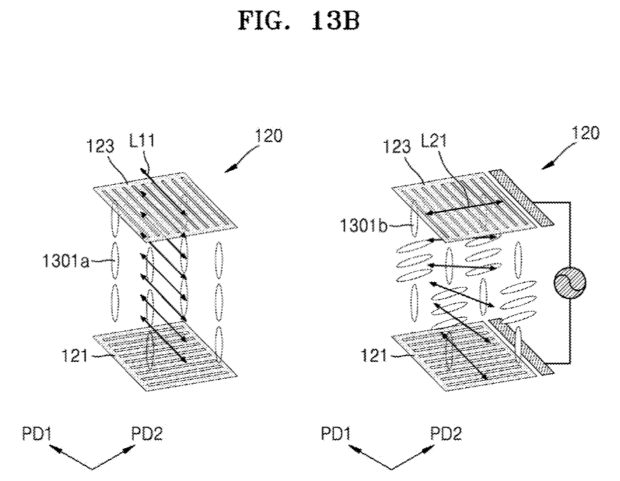

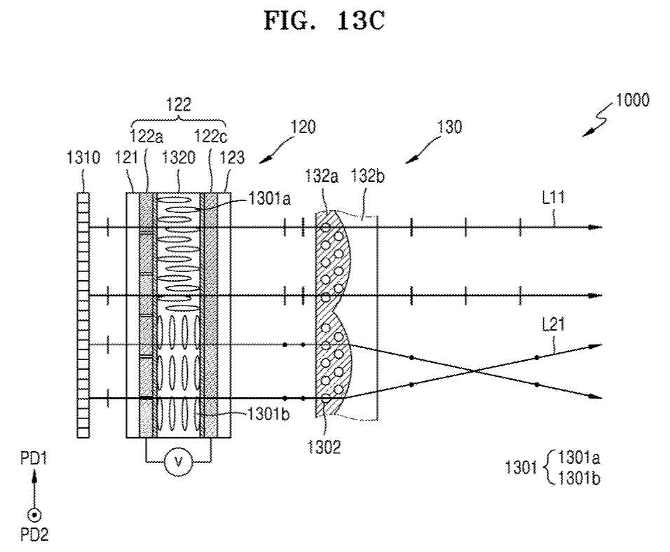

FIG. 13A is a diagram for describing an operation, performed by an electronic device, of displaying an image based on a polarization information map, according to an embodiment of the disclosure. FIG. 13B is a diagram for describing liquid-crystal alignments of a polarization control array according to an embodiment of the disclosure. FIG. 13C is a diagram for describing an operation, performed by an electronic device, of displaying an image based on a polarization information map, according to an embodiment of the disclosure.

Referring to FIGS. 13A, 13B, and 13C, in an embodiment of the disclosure, the electronic device 1000 may include the display 110, the polarization control array 120, and the lens array 130.

In an embodiment of the disclosure, the polarization control array 120 may include the first glass substrate 121, the second glass substrate 123, and a liquid-crystal cell 122 arranged between the first glass substrate 121 and the second glass substrate 123. The liquid crystal cell 122 illustrated in FIG. 13C may correspond to the second liquid crystal cell 122 illustrated in FIGS. 3A and 3B. The liquid-crystal cell 122 of the polarization control array 120 may include a lower electrode layer 122a, a liquid-crystal layer 1320, and an upper electrode layer 122c. Liquid-crystal molecules 1301 may be arranged in the liquid-crystal layer 1320. In the disclosure, the liquid-crystal molecules 1301 in the liquid-crystal layer 1320 of the polarization control array 120 may be referred to as first liquid-crystal molecules. In the following descriptions, the liquid-crystal molecules 1301 in the liquid-crystal layer 1320 of the polarization control array 120 will be referred to as the first liquid-crystal molecules 1301.

In an embodiment of the disclosure, the liquid-crystal layer 1320 may be arranged in a VA mode. When no voltage is applied to the liquid-crystal cell 122 of the polarization control array 120, first liquid-crystal molecules 1301a may be aligned perpendicularly to the first glass substrate 121 and the second glass substrate 123. When a voltage is applied to the liquid-crystal cell 122 of the polarization control array 120, first liquid-crystal molecules 1301b may be aligned parallel to the first glass substrate 121 and the second glass substrate 123.

Light that has passed through the display 110 and is incident on the polarization control array 120 may have a first polarization direction PD1 corresponding to the polarization direction of an upper polarizing plate 1310 of the display 110, as it passes through the upper polarizing plate 1310. For example, in a case in which the display 110 is an LCD, the upper polarizing plate 1310 may correspond to the second polarizing plate 113 (see FIG. 3A) arranged on the liquid-crystal cell 112 (see FIG. 3A) of the display 110. For example, in a case in which the display 110 is an OLED display, the upper polarizing plate 1310 may correspond to the polarizing plate 114-1 (see FIG. 4) on the display element layer 113-1 (see FIG. 4) of the display 110.

In an embodiment of the disclosure, when no voltage is applied to the liquid-crystal cell 122 of the polarization control array 120, the polarization direction of light incident on the polarization control array 120 may be maintained. When the polarization control array 120 is aligned in a VA structure and no voltage is applied thereto, the first liquid-crystal molecules 1301a may be aligned in a direction perpendicular to the first and second glass substrates 121 and 123. Accordingly, the polarization direction of light incident on the polarization control array 120 may be maintained while the light is passing through the polarization control array 120. That is, the polarization direction of light L11 that has passed through the polarization control array 120 may be maintained as the first polarization direction PD1.

In an embodiment of the disclosure, when a voltage is applied to the polarization control array 120, the polarization direction of light incident on the polarization control array 120 may be changed. When the polarization control array 120 is aligned in a VA structure and a voltage is applied thereto, the alignment of the first liquid-crystal molecules 1301b may be changed to be parallel to the first and second glass substrates 121 and 123. As light incident on the polarization control array 120 passes through, its polarization direction may be rotated by 90 degrees on a plane parallel to the first and second glass substrates 121 and 123. That is, the polarization direction of light L21 that has passed through the polarization control array 120 may be changed to a second polarization direction PD2, which is orthogonal to the first polarization direction PD1, on a plane parallel to the first and second glass substrates 121 and 123.

The lens array 130 may include lenses 132a and the resin layer 132b. The lens 132a may include liquid-crystal molecules 1302. In the disclosure, the liquid-crystal molecules 1302 in the lenses 132a may be referred to as second liquid-crystal molecules. In the following descriptions, the liquid-crystal molecules 1302 in the lenses 132a will be referred to as the second liquid-crystal molecules 1302.

When the polarization control array 120 is aligned in a VA mode, the second liquid-crystal molecules 1302 included in the lenses 132a may be aligned in the second polarization direction PD2, which is orthogonal to the polarization direction of the upper polarizing plate 1310 of the display 110. That is, when the polarization control array 120 is aligned in a VA mode, the lenses 132a may be subjected to a rubbing process in the second polarization direction PD2, such that the second liquid-crystal molecules 1302 are aligned in the second polarization direction PD2.

The lens 132a may have birefringent properties. The lens 132a may include an optically anisotropic material. The refractive index of the lens 132a may vary depending on the polarization direction of light entering the lens 132a. For example, a refractive index of the lens in a long-axis direction of the second liquid-crystal molecules 1302 (i.e., an axial refractive index n_e) may be different from a refractive index of the lens 132a in a direction other than the long-axis direction of the second liquid-crystal molecules 1302 (e.g., a direction perpendicular to the long-axis direction) (i.e., an orthotropic refractive index n_o). The refractive index of the lens 132a may vary depending on the polarization direction of incident light. For example, depending on the polarization direction of incident light, the refractive index of the lens 132a may be the axial refractive index n_e or the orthotropic refractive index n_o.

When the light L11 incident on the lens array 130 has the first polarization direction PD1, the polarization direction of the light L11 incident on the lens array 130 may be orthogonal to the long-axis direction of the second liquid-crystal molecules 1302. Accordingly, as the light L11, which is polarized perpendicularly to the long-axis direction of the second liquid-crystal molecules 1302, is incident on the lens 132a, the lens 132a may have the orthotropic refractive index n_o.

The refractive index of the resin layer 132b may be substantially equal to the orthotropic refractive index n_o of the lens 132a. Accordingly, when the light L11 incident on the lens array 130 has the first polarization direction PD1, the lens 132a has the orthotropic refractive index n_o and thus has a refractive index equal to that of the resin layer 132b, such that the light L11 passing through the lens 132a may not be refracted. The light L11 that has not been refracted while passing through the liquid-crystal lens may provide a two-dimensional image to the user. That is, when the liquid-crystal layer 1320 of the polarization control array 120 is aligned in a VA mode and no voltage is applied to the polarization control array 120, the light L11 passing through the lens 132a may be not refracted, thereby providing a two-dimensional image to the user.

When the light L21 incident on the lens array 130 has the second polarization direction PD2, the polarization direction of the light L21 incident on the lens array 130 may be parallel to the long-axis direction of the second liquid-crystal molecules 1302. Accordingly, as light, which is polarized parallel to the long-axis direction of the second liquid-crystal molecules 1302, is incident on the lens 132a, the lens 132a may have the axial refractive index n_e.

The refractive index of the resin layer 132b may be substantially equal to the orthotropic refractive index n_o of the lens 132a. Accordingly, when the light L21 incident on the lens array 130 has the second polarization direction PD2, the lens 132a has the axial refractive index n_e and thus has a refractive index different from that of the resin layer 132b, such that the light L21 passing through the lens 132a may be refracted. The light L21 that has been refracted while passing through the liquid-crystal lens may provide a three-dimensional image to the user. That is, when the liquid-crystal layer 1320 of the polarization control array 120 is arranged in a VA mode and a voltage is applied to the polarization control array 120, the light L21 passing through the lens 132a may be refracted, thereby providing a three-dimensional image to the user.

According to an embodiment of the disclosure, because the polarization control array 120 has a liquid-crystal alignment of a VA mode, the electronic device 1000 may have a relatively wide viewing angle. This is because, in the liquid-crystal alignment of the VA mode, the first liquid-crystal molecules 1301a are aligned in a vertical direction in a default state in which no voltage is applied. In addition, in the liquid-crystal alignment of the VA mode, relatively little distortion may occur even when a user views the screen from various angles, and thus, the electronic device 1000 may achieve a higher contrast ratio and a wider range of color reproduction.

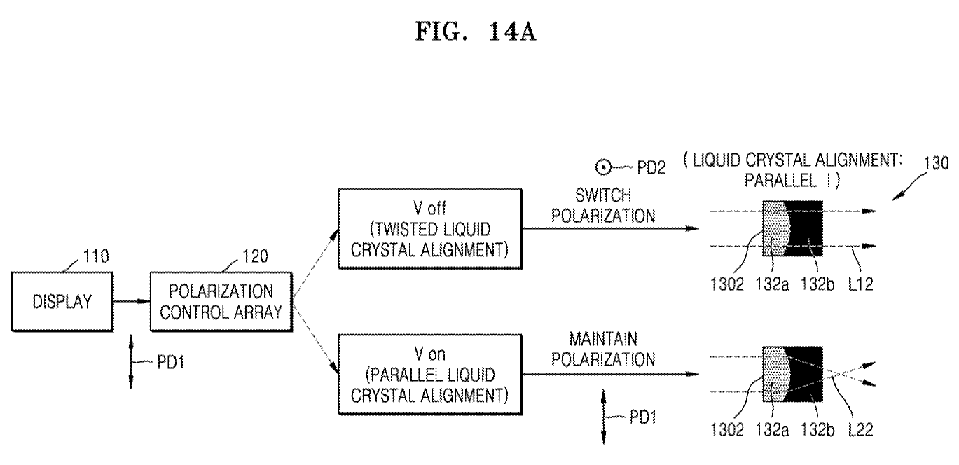

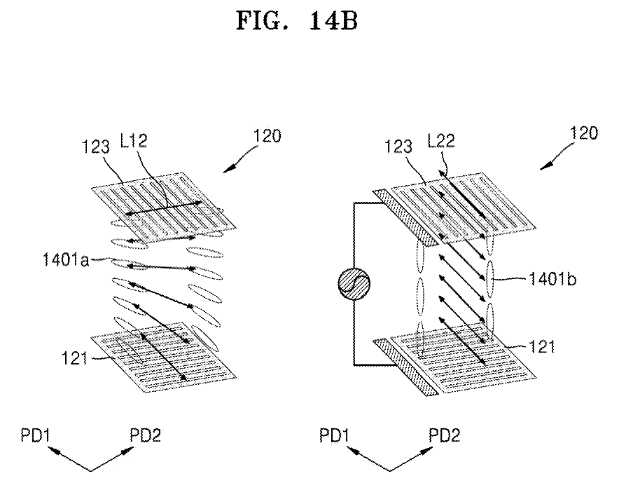

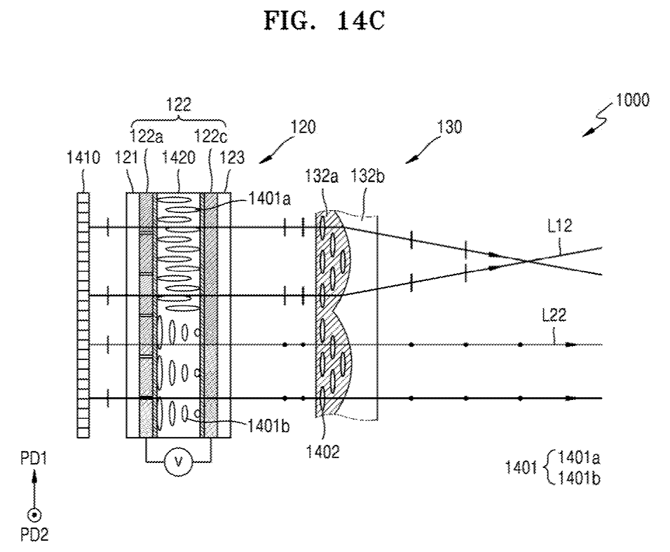

FIG. 14A is a diagram for describing an operation, performed by an electronic device, of displaying an image based on a polarization information map, according to an embodiment of the disclosure. FIG. 14B is a diagram for describing liquid-crystal alignments of a polarization control array according to an embodiment of the disclosure. FIG. 14C is a diagram for describing an operation, performed by an electronic device, of displaying an image based on a polarization information map, according to an embodiment of the disclosure.

Referring to FIGS. 14A, 14B, and 14C, in an embodiment of the disclosure, the electronic device 1000 may include the display 110, the polarization control array 120, and the lens array 130.

In an embodiment of the disclosure, the polarization control array 120 may include the first glass substrate 121, the second glass substrate 123, and a liquid-crystal cell 122 arranged between the first glass substrate 121 and the second glass substrate 123. The liquid-crystal cell 122 of the polarization control array 120 may include the lower electrode layer 122a, a liquid-crystal layer 1420, and the upper electrode layer 122c. Liquid-crystal molecules 1401 may be arranged in the liquid-crystal layer 1420. In the disclosure, the liquid-crystal molecules 1401 in the liquid-crystal layer 1420 of the polarization control array 120 may be referred to as first liquid-crystal molecules. In the following descriptions, the liquid-crystal molecules 1401 in the liquid-crystal layer 1420 of the polarization control array 120 will be referred to as the first liquid-crystal molecules 1401.

In an embodiment of the disclosure, the liquid-crystal layer 1420 may be aligned in a TN mode. When no voltage is applied to the liquid-crystal cell 122 of the polarization control array 120, the first liquid-crystal molecules 1301a may be aligned parallel to the first glass substrate 121 and the second glass substrate 123 and gradually twisted (or rotated) from the first glass substrate 121 to the second glass substrate 123. When a voltage is applied to the liquid-crystal cell 122 of the polarization control array 120, the first liquid-crystal molecules 1301b may be aligned in a direction perpendicular to the first glass substrate 121 and the second glass substrate 123.

Light that has passed through the display 110 and is incident on the polarization control array 120 may have the first polarization direction PD1 corresponding to the polarization direction of an upper polarizing plate 1410 of the display 110, as it passes through the upper polarizing plate 1410. For example, in a case in which the display 110 is an LCD, the upper polarizing plate 1410 may correspond to the second polarizing plate 113 (see FIG. 3A) arranged on the liquid-crystal cell 112 (see FIG. 3A) of the display 110. For example, in a case in which the display 110 is an OLED display, the upper polarizing plate 1410 may correspond to the polarizing plate 114-1 (see FIG. 4) on the display element layer 113-1 (see FIG. 4) of the display 110.

In an embodiment of the disclosure, when no voltage is applied to the liquid-crystal cell 122 of the polarization control array 120, the polarization direction of light incident on the polarization control array 120 may be changed. When the polarization control array 120 is aligned in a TN structure and no voltage is applied to the polarization control array 120, first liquid-crystal molecules 1401a may be aligned parallel to the first and second glass substrates 121 and 123 and gradually twisted by about 90 degrees. Accordingly, the polarization direction of light incident on the polarization control array 120 may be rotated by 90 degrees on a plane parallel to the first and second glass substrates 121 and 123. That is, the polarization direction of light L12 that has passed through the polarization control array 120 may be changed to the second polarization direction PD2, which is orthogonal to the first polarization direction PD1, on a plane parallel to the first and second glass substrates 121 and 123.

In an embodiment of the disclosure, when a voltage is applied to the polarization control array 120, the polarization direction of light incident on the polarization control array 120 may be maintained. When the polarization control array 120 is aligned in a TN structure and a voltage is applied to the polarization control array 120, the alignment of first liquid-crystal molecules 1401b may be changed to be perpendicular to the first and second glass substrates 121 and 123. The polarization direction of light incident on the polarization control array 120 may be maintained while the light is passing through the polarization control array 120. That is, the polarization direction of light L22 that has passed through the polarization control array 120 may be maintained as the first polarization direction PD1.

The lens array 130 may include lenses 132a and the resin layer 132b. The lens 132a may include liquid-crystal molecules 1402. In the disclosure, the liquid-crystal molecules 1402 in the lenses 132a may be referred to as second liquid-crystal molecules. In the following descriptions, the liquid-crystal molecules 1402 in the lenses 132a will be referred to as the second liquid-crystal molecules 1402.

When the polarization control array 120 is aligned in a TN mode, the second liquid-crystal molecules 1402 included in the lenses 132a may be aligned in the first polarization direction PD1, which is parallel to the polarization direction of the upper polarizing plate 1410 of the display 110. That is, when the polarization control array 120 is aligned in a TN mode, the lenses 132a may be subjected to a rubbing process in the first polarization direction PD1, such that the second liquid-crystal molecules 1402 are aligned in the first polarization direction PD1.

The lens 132a may have birefringent properties. The lens 132a may include an optically anisotropic material. The refractive index of the lens 132a may vary depending on the polarization direction of light entering the lens 132a. For example, a refractive index of the lens in the long-axis direction of the second liquid-crystal molecules 1402 (i.e., an axial refractive index n_e) may be different from a refractive index of the lens 132a in a direction other than the long-axis direction of the second liquid-crystal molecules 1402 (e.g., a direction perpendicular to the long-axis direction) (i.e., an orthotropic refractive index n_o). The refractive index of the lens 132a may vary depending on the polarization direction of incident light. For example, depending on the polarization direction of incident light, the refractive index of the lens 132a may be the axial refractive index n_e or the orthotropic refractive index n_o.

When the light L12 incident on the lens array 130 has the second polarization direction PD2, the polarization direction of the light L12 incident on the lens array 130 may be orthogonal to the long-axis direction of the second liquid-crystal molecules 1402. Accordingly, as the light L12, which is polarized perpendicularly to the long-axis direction of the second liquid-crystal molecules 1402, is incident on the lens 132a, the lens 132a may have the orthotropic refractive index n_o.

The refractive index of the resin layer 132b may be substantially equal to the orthotropic refractive index n_o of the lens 132a. Accordingly, when the light L12 incident on the lens array 130 has the second polarization direction PD2, the lens 132a has the orthotropic refractive index n_o and thus has a refractive index equal to that of the resin layer 132b, such that the light L12 passing through the lens 132a may not be refracted. The light L12 that has not been refracted while passing through the liquid-crystal lens may provide a two-dimensional image to the user. That is, when the liquid-crystal layer 1320 of the polarization control array 120 is aligned in a TN mode and no voltage is applied to the polarization control array 120, the light L12 passing through the lens 132a may be not refracted, thereby providing a two-dimensional image to the user.

When the light L22 incident on the lens array 130 has the first polarization direction PD1, the polarization direction of the light L22 incident on the lens array 130 may be parallel to the long-axis direction of the second liquid-crystal molecules 1402. Accordingly, as light, which is polarized parallel to the long-axis direction of the second liquid-crystal molecules 1402, is incident on the lens 132a, the lens 132a may have the axial refractive index n_e.

The refractive index of the resin layer 132b may be substantially equal to the orthotropic refractive index n_o of the lens 132a. Accordingly, when the light L22 incident on the lens array 130 has the first polarization direction PD1, the lens 132a has the axial refractive index n_e and thus has a refractive index different from that of the resin layer 132b, such that the light L22 passing through the lens 132a may be refracted. The light L22 that has been refracted while passing through the liquid-crystal lens may provide a three-dimensional image to the user. That is, when the liquid-crystal layer 1420 of the polarization control array 120 is arranged in a TN mode and a voltage is applied to the polarization control array 120, the light L22 passing through the lens 132a may be refracted, thereby providing a three-dimensional image to the user.

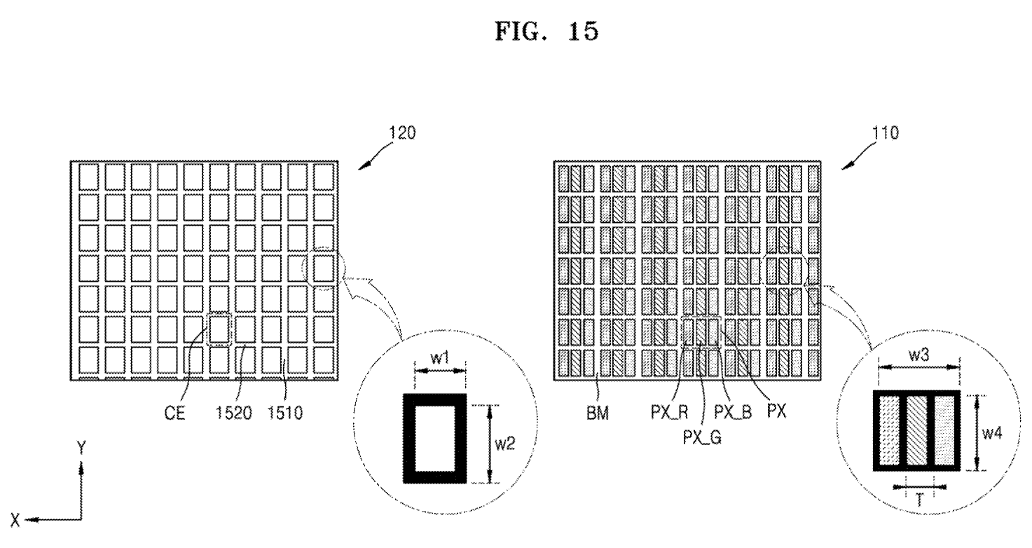

FIG. 15 is a diagram for describing a planar structure of a polarization control array and a pixel array, according to an embodiment of the disclosure.

Referring to FIG. 15, in an embodiment of the disclosure, the polarization control array 120 may include a lower electrode layer 122a (see FIG. 3A) that includes electrodes 1510 arranged in an X-direction, and an upper electrode layer 122c (see FIG. 3A) that includes electrodes 1520 arranged in a Y-direction. The electrodes 1510 of the lower electrode layer 122a (see FIG. 3A) and the electrodes 1520 of the second electrode layer 122b (see FIG. 3A) may be orthogonal to each other on a plane defined by the X-direction (or a first direction) and the Y-direction (or a second direction), to define one cell CE.

In an embodiment of the disclosure, each cell CE may have a first width w1 in the X-direction and a second width w2 in the Y-direction that is perpendicular to the X-direction. For example, the first width w1 of each cell in the X-direction may be a sum of a gap between adjacent first electrodes 1510 in the X-direction and a thickness of the first electrode 1510 in the X-direction. For example, the second width w2 of each cell in the Y-direction may be a sum of a gap between adjacent second electrodes 1520 in the Y-direction and a thickness of the second electrode 1520 in the Y-direction. Here, the first width w1 of each cell CE in the X-direction may correspond to a pattern period of a lattice pattern formed by the first electrodes 1510 and the second electrodes 1520 on a plane, wherein the pattern period is in the X-direction. The second width w2 of each cell CE in the Y-direction may correspond to a pattern period of a lattice pattern formed by the first electrodes 1510 and the second electrodes 1520 on a plane, wherein the pattern period is in the Y-direction.

In an embodiment of the disclosure, the display 110 may include a plurality of pixels. The plurality of pixels may be arranged in the X-direction and the Y-direction. Each of the pixels may include a first sub-pixel PX_R, a second sub-pixel PX_G, and a third sub-pixel PX_B. For example, the first sub-pixel PX_R may emit light of a first color (e.g., red light), the second sub-pixel PX_G may emit light of a second color (e.g., green light), and the third sub-pixel PX_B may emit light of a third color (e.g., blue light). However, embodiments of the disclosure are not limited thereto, and sub-pixels included in a unit pixel may emit light of various colors, provided that they may implement white light in combination.

In an embodiment of the disclosure, each pixel PX may include one first sub-pixel PX_R, one second sub-pixel PX_G, and one third sub-pixel PX_B. Within each pixel PX, the first sub-pixel PX_R, the second sub-pixel PX_G, and the third sub-pixel PX_B may be arranged in the X-direction. Each of the first sub-pixel PX_R, the second sub-pixel PX_G, and the third sub-pixel PX_B may have a rectangular or elliptical shape extending in the Y-direction. In addition, an arrangement of the pixels PX, a configuration of sub-pixels in each pixel PX, and an arrangement of the sub-pixels within each pixel PX are not limited to any one embodiment of the disclosure, and various embodiments may be applied.

In an embodiment of the disclosure, the display 110 may further include a black matrix BM (or a pixel defining layer including a light-absorbing material, a black pigment, or a black dye). The black matrix BM (or the pixel defining layer) may separate the pixels PX from each other, and may separate the first sub-pixel PX_R, the second sub-pixel PX_G, and the third sub-pixel PX_B from each other within each pixel. The black matrix BM may prevent color mixture between the sub-pixels and may prevent an increase in a leakage current of a TFT due to an external light source.

The black matrix BM (or the pixel defining layer) may define a first light-emitting region from which light of the first color is emitted by the first sub-pixel PX_R, a second light-emitting region from which light of the second color is emitted by the second sub-pixel PX_G, and a third light-emitting region from which light of the third color is emitted by the third sub-pixel PX_B. A region in which the black matrix BM (or the pixel defining layer) is arranged, excluding the first to third light-emitting regions, may be defined as a peripheral region. FIG. 15 schematically illustrates only the first light-emitting region of the first sub-pixel PX_R, from which light of the first color is emitted, and hereinafter, the first light-emitting region will be described with reference to the same reference numeral as the first sub-pixel PX_R. FIG. 15 schematically illustrates only the second light-emitting region of the second sub-pixel PX_G, from which light of the second color is emitted, and hereinafter, the second light-emitting region will be described with reference to the same reference numeral as the second sub-pixel PX_G. FIG. 15 schematically illustrates only the third light-emitting region of the third sub-pixel PX_B, from which light of the third color is emitted, and hereinafter, the third light-emitting region will be described with reference to the same reference numeral as the third sub-pixel PX_B.

In an embodiment of the disclosure, each pixel PX may have a third width w3 in the X-direction and a fourth width w4 in the Y-direction. For example, the third width w3 of each pixel PX in the X-direction may correspond to a distance between an outer edge of a first light-emitting region PX_R in the X-direction and an outer edge of another first light-emitting region PX_R in the X-direction in another pixel that is adjacent in the X-direction. For example, the fourth width w4 of each pixel PX in the Y-direction may correspond to a distance between an outer edge of a first light-emitting region PX_R (or a second light-emitting region PX_G, or a third light-emitting region PX_B) in the Y-direction and an outer edge of another first light-emitting region PX_R (or another second light-emitting region PX_G, or another third light-emitting region PX_B) in the Y-direction in another pixel that is adjacent in the Y-direction. The third width w3 of each pixel PX in the X-direction may correspond to a first pattern period of a lattice pattern formed by the black matrix BM on a plane, wherein the first pattern period is in the X-direction. The fourth width w4 of each pixel PX in the Y-direction may correspond to a pattern period of a lattice pattern formed by the black matrix BM on a plane, wherein the pattern period is in the Y-direction.

In an embodiment of the disclosure, the first width w1 of each cell and the third width w3 of each pixel may be such that neither is an integer multiple of the other. The pattern period of the lattice pattern formed by the first electrodes 1510 and the second electrodes 1520 in the X-direction, and the first pattern period of the lattice pattern formed by the black matrix BM in the X-direction may be such that neither is an integer multiple of the other.

In an embodiment of the disclosure, the second width w2 of each cell CE and the fourth width w4 of each pixel PX may be such that neither is an integer multiple of the other. The pattern period of the lattice pattern formed by the first electrodes 1510 and the second electrodes 1520 in the Y-direction, and the pattern period of the lattice pattern formed by the black matrix BM in the Y-direction may be such that neither is an integer multiple of the other.

According to an embodiment of the disclosure, a moire phenomenon, in which an interference pattern generated by an overlap of two periodic patterns is perceived, may be reduced. In particular, when two different patterns have pattern periods, one of which is an integer multiple of the other, the two patterns overlap at regular intervals to generate an interference pattern, such that the interference pattern may be perceived by a user. In an embodiment of the disclosure, a cell size and a pixel size may be such that neither is an integer multiple of the other. Accordingly, because the pattern period of the lattice pattern formed by the first electrodes 1510 and the second electrodes 1520 and the pattern period of the lattice pattern formed by the black matrix BM may be such that neither is an integer multiple of the other, an interference pattern between the two lattice patterns may not be generated, and thus, the perception of moire may be reduced or prevented.

In addition, in an embodiment of the disclosure, the lattice pattern formed by the black matrix BM on a plane may have a second pattern period T in the X-direction corresponding to a sub-pixel unit. The second pattern period T in the X-direction may be a sum of a width of one light-emitting region in the X-direction and a gap between adjacent light-emitting regions. In an embodiment of the disclosure, the second pattern period of the lattice pattern formed by the black matrix BM in the X-direction, and the pattern period of the lattice pattern formed by the first electrodes 1510 and the second electrodes 1520 in the Y-direction may be such that neither is an integer multiple of the other.

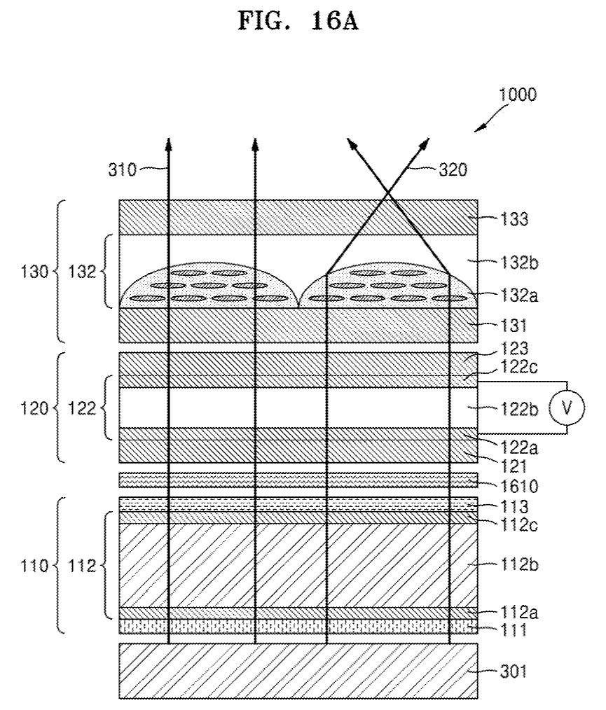

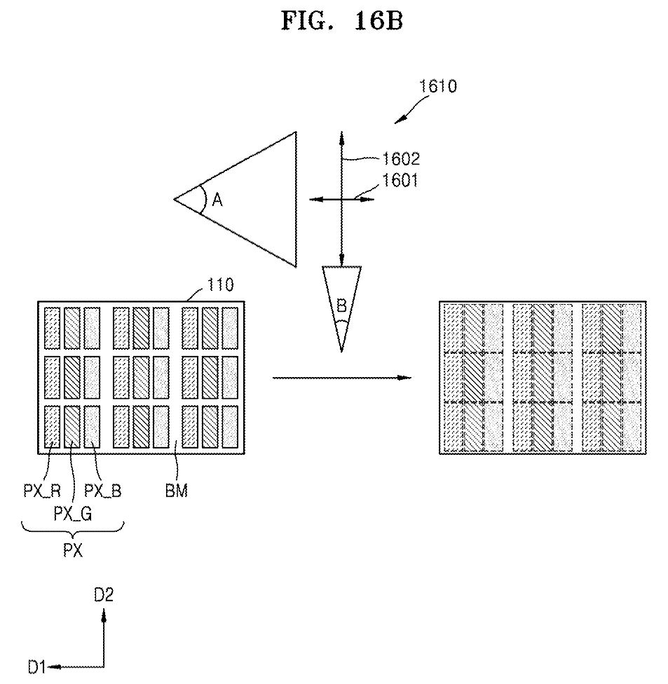

FIG. 16A is a diagram illustrating an electronic device according to an embodiment of the disclosure. FIG. 16B is a diagram for describing an anisotropic diffuser film according to an embodiment of the disclosure.

Referring to FIGS. 16A and 16B, in an embodiment of the disclosure, the electronic device 1000 may include the display 110, an anisotropic diffuser film 1610, the polarization control array 120, and the lens array 130. The electronic device 1000 may further include the anisotropic diffuser film 1610. The anisotropic diffuser film 1610 may be arranged between the display 110 and the polarization control array 120. That is, the anisotropic diffuser film 1610 may be arranged on the display 110 and may be arranged below the polarization control array 120.

The anisotropic diffuser film 1610 may diffuse light to a different degree in different directions. The anisotropic diffuser film 1610 may emphasize or control the diffusion of light only in a particular axial direction. For the anisotropic diffuser film 1610, a diffusion angle in a particular axial direction may be set to be greater than diffusion angles in other directions. For example, for the anisotropic diffuser film 1610, a degree of diffusion 1602 in a second direction D2 (e.g., a vertical direction) that intersects a first direction D1 (e.g., a horizontal direction) may be greater than a degree of diffusion 1601 in the first direction D1. For the anisotropic diffuser film 1610, a diffusion angle A in the second direction D2 (e.g., a vertical direction) may be greater than a diffusion angle B in the first direction D1 (e.g., a horizontal direction). Here, the first direction D1 in FIG. 16B may be identical to or different from the above-described X-direction. The second direction D2 in FIG. 16B may be identical to or different from the above-described Y-direction.

For example, the electronic device 1000 may further include an elliptical light distribution control film (or an elliptical light distribution control sheet), as an example of the anisotropic diffuser film 1610. The elliptical light distribution control film may change a diffusion pattern of light into an elliptical shape. For the elliptical light distribution control film, a degree to which light is diffused in a minor-axis direction may be greater than a degree to which light is diffused in a major-axis direction. The elliptical light distribution control film may control a diffusion direction of light without light loss. Accordingly, by using the elliptical light distribution control film, the electronic device 1000 may diffuse light without a loss of screen luminance.

As illustrated in FIG. 16B, in an embodiment of the disclosure, a plurality of pixels PX within the display 110 may be arranged in the first direction D1 and the second direction D2. Each pixel PX may include the first sub-pixel PX_R, the second sub-pixel PX_G, and the third sub-pixel PX_B. For example, the first sub-pixel PX_R may emit light of a first color (e.g., red light), the second sub-pixel PX_G may emit light of a second color (e.g., green light), and the third sub-pixel PX_B may emit light of a third color (e.g., blue light). Within each pixel PX, one first sub-pixel PX_R, one second sub-pixel PX_G, and one third sub-pixel PX_B may be arranged in the first direction D1. A plurality of first sub-pixels may be arranged in the second direction D2. A plurality of second sub-pixels may be arranged in the second direction D2. A plurality of third sub-pixels may be arranged in the second direction D2.

In an embodiment of the disclosure, the display 110 may further include the black matrix BM (or a pixel defining layer including a light-absorbing material, a black pigment, or a black dye). The black matrix BM (or the pixel defining layer) may separate the pixels PX from each other, and may separate the first sub-pixel PX_R, the second sub-pixel PX_G, and the third sub-pixel PX_B from each other within each pixel. The black matrix BM (or the pixel defining layer) may define a first light-emitting region from which light of the first color is emitted by the first sub-pixel PX_R, a second light-emitting region from which light of the second color is emitted by the second sub-pixel PX_G, and a third light-emitting region from which light of the third color is emitted by the third sub-pixel PX_B. A region in which the black matrix BM (or the pixel defining layer) is arranged, excluding the first to third light-emitting regions, may be defined as a peripheral region.

In an embodiment of the disclosure, as light that has passed through the display 110 passes through the anisotropic diffuser film 1610, the degree of diffusion 1601 in the first direction D1 and the degree of diffusion 1602 in the second direction D2 may differ from each other. As light that has passed through the display 110 passes through the anisotropic diffuser film 1610, the diffusion angle B in the first direction D1 and the diffusion angle A in the second direction D2 may differ from each other. For example, for light passing through the anisotropic diffuser film 1610, the degree of diffusion 1602 in the second direction D2 may be greater than the degree of diffusion 1601 in the first direction D1. For light passing through the anisotropic diffuser film 1610, the diffusion angle A in the second direction D2 may be greater than the diffusion angle B in the first direction D1.

In an embodiment of the disclosure, for the anisotropic diffuser film 1610, a degree of diffusion in a direction in which sub-pixels emitting light of the same color are arranged may be greater than a degree of diffusion in a direction in which sub-pixels emitting light of different colors are arranged. For the anisotropic diffuser film 1610, a diffusion angle in a direction in which sub-pixels emitting light of the same color are arranged may be greater than a diffusion angle in a direction in which sub-pixels emitting light of different colors are arranged.

Accordingly, because light passing through the anisotropic diffuser film 1610 has a relatively large degree of diffusion in a direction in which sub-pixels providing light of the same color are arranged, a degree of visibility of the black matrix BM between the sub-pixels providing light of the same color may be reduced. Thus, the perception of moire occurring due to interference with the black matrix may be reduced or prevented. Furthermore, because light passing through the anisotropic diffuser film 1610 has a relatively small degree of diffusion in a direction in which sub-pixels providing light of different colors are arranged, color mixture may be reduced or prevented. Thus, according to an embodiment of the disclosure, the electronic device 1000 may reduce moire by using light diffusion while preventing color mixture between sub-pixels.

To solve the above-described technical issues, an embodiment of the disclosure provides an electronic device 1000.

In an embodiment of the disclosure, the electronic device 1000 may include a display 110. In an embodiment of the disclosure, the electronic device 1000 may include a lens array 130. In an embodiment of the disclosure, the electronic device 1000 may include a polarization control array 120 arranged between the display 110 and the lens array 130 and configured to control a polarization direction of light provided from the display 110. In an embodiment of the disclosure, the electronic device 1000 may include at least one processor 150. In an embodiment of the disclosure, the electronic device 1000 may include memory 140 storing a plurality of instructions.

In an embodiment of the disclosure, the plurality of instructions, when executed by at least one processor 150 individually or collectively, may cause the electronic device 1000 to obtain an input image and information about a two-dimensional display region and a three-dimensional display region of the input image. In an embodiment of the disclosure, the plurality of instructions, when executed by the at least one processor 150 individually or collectively, may cause the electronic device 1000 to generate, based on the obtained input image and the information about the two-dimensional display region and the three-dimensional display region of the obtained input image, a polarization information map including at least one of a two-dimensional region corresponding to the two-dimensional display region or a three-dimensional region corresponding to the three-dimensional display region. In an embodiment of the disclosure, the plurality of instructions, when executed by the at least one processor 150 individually or collectively, may cause the electronic device 1000 to synchronize the display 110 and the polarization control array 120 to simultaneously control the display 110 to display an image based on the input image, and control the polarization control array 120 to control a liquid-crystal alignment of the polarization control array 120 based on the polarization information map. In an embodiment of the disclosure, the plurality of instructions, when executed by the at least one processor 150 individually or collectively, may cause the electronic device 1000 to control the polarization control array 120 such that a liquid-crystal alignment in a two-dimensional control region of the polarization control array 120 corresponding to the two-dimensional region is different from a liquid-crystal alignment in a three-dimensional control region of the polarization control array 120 corresponding to the three-dimensional region. In an embodiment of the disclosure, the plurality of instructions, when executed by the at least one processor 150 individually or collectively, may cause the electronic device 1000 to provide the image that is displayed two-dimensionally in at least a portion or three-dimensionally in at least a portion, based on degrees of refraction of light beams in the lens array 130 that have passed through the two-dimensional control region and the three-dimensional control region, respectively, and have different polarization directions.

In an embodiment of the disclosure, the plurality of instructions, when executed by the at least one processor 150 individually or collectively, may cause the electronic device 1000 to set a boundary region between the two-dimensional region and the three-dimensional region within the polarization information map. In an embodiment of the disclosure, the plurality of instructions, when executed by the at least one processor 150 individually or collectively, may cause the electronic device 1000 to, based on the polarization information map, apply a first voltage to the three-dimensional region or the two-dimensional region of the polarization control array 120, and apply a second voltage, which has a value between zero and the first voltage, i.e., an intermediate value of the first voltage, to the boundary region of the polarization control array 120.

In an embodiment of the disclosure, the display region may include a first display region and a second display region. In an embodiment of the disclosure, the input image may include a first input image to be displayed in the first display region, and a second input image to be displayed in the second display region. In an embodiment of the disclosure, the plurality of instructions, when executed by the at least one processor 150 individually or collectively, may cause the electronic device 1000 to identify the two-dimensional display region based on pixel value information at corresponding pixels between the first input image and the second input image being identical, and identify the three-dimensional display region based on pixel value information at corresponding pixels between the first input image and the second input image being different.

In an embodiment of the disclosure, the plurality of instructions, when executed by the at least one processor 150 individually or collectively, may cause the electronic device 1000 to receive image data including a first label value assigned to pixels corresponding to the two-dimensional display region, and a second label value assigned to pixels corresponding to the three-dimensional display region in the input image.

In an embodiment of the disclosure, the plurality of instructions, when executed by the at least one processor 150 individually or collectively, may cause the electronic device 1000 to identify an image (or visual content) in the input image. In an embodiment of the disclosure, the plurality of instructions, when executed by the at least one processor 150 individually or collectively, may cause the electronic device 1000 to identify the three-dimensional display region in the input image based on the identified image (or the identified visual content).

In an embodiment of the disclosure, the plurality of instructions, when executed by the at least one processor 150 individually or collectively, may cause the electronic device 1000 to obtain information about a preset three-dimensional display region in the input image. In an embodiment of the disclosure, the plurality of instructions, when executed by the at least one processor 150 individually or collectively, may cause the electronic device 1000 to identify the three-dimensional display region based on the information about the preset three-dimensional display region.

In an embodiment of the disclosure, the plurality of instructions, when executed by the at least one processor 150 individually or collectively, may cause the electronic device 1000 to activate a synchronization signal after the polarization information map is generated. In an embodiment of the disclosure, the plurality of instructions, when executed by the at least one processor 150 individually or collectively, may cause the electronic device 1000 to activate and input a first scan signal to the display 110 in synchronization with the synchronization signal, and activate and input a second scan signal to the polarization control array 120 in synchronization with the synchronization signal.

In an embodiment of the disclosure, the display 110 may include a first polarizing plate 111, a second polarizing plate 113 having a polarization axis in a first polarization direction, and a first liquid-crystal layer 112b arranged between the first polarizing plate 111 and the second polarizing plate 113. In an embodiment of the disclosure, the lens array 130 may include a liquid-crystal lens 132 aligned in a direction orthogonal to the first polarization direction.

In an embodiment of the disclosure, the display 110 may include a display element layer 113-1 including a light-emitting element, and an upper polarizing plate 114-1 arranged on the display element layer 113-1 and having a polarization axis in a first polarization direction. In an embodiment of the disclosure, the lens array 130 may include a liquid-crystal lens 132 aligned in a direction orthogonal to the first polarization direction.

In an embodiment of the disclosure, the polarization control array 120 may include a second liquid-crystal layer 122b that is driven in a VA mode. In an embodiment of the disclosure, the plurality of instructions, when executed by the at least one processor 150 individually or collectively, may cause the electronic device 1000 to, based on the polarization information map, apply no voltage to the two-dimensional control region of the polarization control array 120 corresponding to the two-dimensional region, and apply a voltage to the three-dimensional control region of the polarization control array 120 corresponding to the three-dimensional region.

In an embodiment of the disclosure, the display 110 may include a plurality of pixels PX, each including a first sub-pixel PX_R that provides light of a first color, a second sub-pixel PX_G that provides light of a second color, and a third sub-pixel PX_B that provides light of a third color. In an embodiment of the disclosure, the polarization control array 120 may include a plurality of first electrodes 1510 and a plurality of second electrodes 1520 that intersect the plurality of first electrodes 1510 on a plane. In an embodiment of the disclosure, a first width w1, in a first direction, of each of cells CE defined by the plurality of first electrodes 1510 and the plurality of second electrodes 1520 intersecting each other, and a second width w2, in the first direction, of each of the plurality of pixels PX may be such that neither is an integer multiple of the other. In an embodiment of the disclosure, a third width w3 of each of the cells CE in a second direction that is orthogonal to the first direction, and a fourth width w4 of each of the plurality of pixels PX in the second direction may be such that neither is an integer multiple of the other.

In an embodiment of the disclosure, the electronic device 1000 may further include an anisotropic diffuser film 1610 arranged between the display 110 and the polarization control array 120. In an embodiment of the disclosure, the display 110 may include a plurality of pixels PX, each including a first sub-pixel PX_R that provides light of a first color, a second sub-pixel PX_G that provides light of a second color, and a third sub-pixel PX_B that provides light of a third color. In an embodiment of the disclosure, in each of the plurality of pixels PX, the first sub-pixel PX_R, the second sub-pixel PX_G, and the third sub-pixel PX_B may be arranged in a first direction, and the first sub-pixels PX_R, the second sub-pixels PX_G, and the third sub-pixels PX_B of the plurality of pixels PX may be respectively arranged in a second direction that is orthogonal to the first direction. In an embodiment of the disclosure, a degree of diffusion of light by the anisotropic diffuser film 1610 in the second direction may be greater than a degree of diffusion of light by the anisotropic diffuser film 1610 in the first direction.

To solve the above-described technical issues, an embodiment of the disclosure provides an operating method of an electronic device 1000. In the operating method of the electronic device 1000 according to an embodiment of the disclosure, the electronic device 1000 may include a display 110, a lens array 130, and a polarization control array 120 configured to control a polarization direction of light provided from the display 110, and may provide an image to a display region.

In an embodiment of the disclosure, the operating method of the electronic device 1000 may include obtaining an input image and information about a two-dimensional display region and a three-dimensional display region of the input image (S510). In an embodiment of the disclosure, the operating method of the electronic device 1000 may include generating, based on the obtained input image and the obtained information about the two-dimensional display region and the three-dimensional display region of the input image, a polarization information map including at least one of a two-dimensional region corresponding to the two-dimensional display region or a three-dimensional region corresponding to the three-dimensional display region (S520). In an embodiment of the disclosure, the operating method of the electronic device 1000 may include synchronizing the display 110 and the polarization control array 120 to simultaneously control the display 110 to display the image via the display 110 based on the input image, and control the polarization control array 120 to control a liquid-crystal alignment of the polarization control array 120 based on the polarization information map (S530). In an embodiment of the disclosure, the operating method of the electronic device 1000 may include controlling the polarization control array 120 such that a liquid-crystal alignment in the two-dimensional control region of the polarization control array 120 corresponding to the two-dimensional region is different from a liquid-crystal alignment in the three-dimensional control region of the polarization control array 120 corresponding to the three-dimensional region (S540). In an embodiment of the disclosure, the operating method of the electronic device 1000 may include providing the image that is displayed two-dimensionally in at least a portion or three-dimensionally in at least a portion, based on degrees of refraction of light beams in the lens array 130 that have passed through the two-dimensional control region and the three-dimensional control region, respectively, and have different polarization directions (S550).

In an embodiment of the disclosure, the operating method of the electronic device 1000 may include setting a boundary region between the two-dimensional region and the three-dimensional region within the polarization information map.

In an embodiment of the disclosure, the controlling of the polarization control array 120 such that the liquid-crystal alignment in the two-dimensional control region is different from the liquid-crystal alignment in the three-dimensional control region may include, based on the polarization information map, applying a first voltage to the three-dimensional region or the two-dimensional region of the polarization control array 120, and applying a second voltage, which has a value between zero and the first voltage, i.e., have an intermediate value of the first voltage, to the boundary region of the polarization control array 120.

In an embodiment of the disclosure, the obtaining of the information about the two-dimensional display region and the three-dimensional display region of the input image (S510) may include identifying the two-dimensional display region based on pixel values at corresponding pixels between the first input image and the second input image being identical, and identifying the three-dimensional display region based on pixel values at corresponding pixels between the first input image and the second input image being different.

In an embodiment of the disclosure, the obtaining of the information about the two-dimensional display region and the three-dimensional display region of the input image (S510) may include receiving image data including a first label value assigned to pixels corresponding to the two-dimensional display region, and a second label value assigned to pixels corresponding to the three-dimensional display region in the input image.

In an embodiment of the disclosure, the obtaining of the information about the two-dimensional display region and the three-dimensional display region of the input image (S510) may include identifying an image (or visual content) in the input image. In an embodiment of the disclosure, the obtaining of the information about the two-dimensional display region and the three-dimensional display region of the input image (S510) may include identifying the three-dimensional display region in the input image based on the identified image (or the identified visual content).

In an embodiment of the disclosure, the obtaining of the information about the two-dimensional display region and the three-dimensional display region of the input image (S510) may include obtaining information about a preset three-dimensional display region in the input image. In an embodiment of the disclosure, the obtaining of the information about the two-dimensional display region and the three-dimensional display region of the input image (S510) may include identifying the three-dimensional display region based on the information about the preset three-dimensional display region.

In an embodiment of the disclosure, the synchronizing of the display 110 and the polarization control array 120 to simultaneously control the display 110 and the polarization control array 120 may include activating a synchronization signal after the polarization information map is generated. In an embodiment of the disclosure, the operating method of the electronic device 1000 may include activating and inputting a first scan signal to the display 110 in synchronization with the synchronization signal, and activating and inputting a second scan signal to the polarization control array 120 in synchronization with the synchronization signal.

To solve the above-described technical issues, there may be provided a computer-readable recording medium having recorded thereon a program for causing a computer to execute a operating method of an electronic device according to at least one of embodiments of the disclosure.

A program executable by the electronic device described herein may be implemented as a hardware component, a software component, and/or a combination of hardware components and software components. The program is executable by any system capable of executing computer-readable instructions.

The software may include a computer program, code, instructions, or a combination of one or more thereof, and may configure a processor to operate as desired or may independently or collectively instruct the processor.

The software may be implemented as a computer program that includes instructions stored in computer-readable storage media. The computer-readable storage media may include, for example, magnetic storage media (e.g., ROM, RAM, floppy disks, or hard disks) and optical storage media (e.g., a compact disc ROM (CD-ROM) or a digital versatile disc (DVD)). The computer-readable recording medium may be distributed in computer systems connected via a network and may store and execute computer-readable code in a distributed manner. The recording medium may be computer-readable, may be stored in memory, and may be executed by a processor.

The computer-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

In an embodiment of the disclosure, there may be provided a non-transitory computer-readable recording medium having recorded therein instructions executable by at least one processor of an electronic device. The instructions executable by the at least one processor of the electronic device may cause the electronic device to: obtain an input image and information about a two-dimensional display region and a three-dimensional display region of the input image, generate, based on the input image and the information about the two-dimensional display region and the three-dimensional display region of the input image, a polarization information map comprising at least one of a two-dimensional region corresponding to the two-dimensional display region or a three-dimensional region corresponding to the three-dimensional display region, synchronize the display and the polarization control array to simultaneously control the display to display the image via the display based on the input image, control the polarization control array to control a liquid-crystal alignment of the polarization control array based on the polarization information map, control the polarization control array such that a first liquid-crystal alignment in a two-dimensional control region of the polarization control array corresponding to the two-dimensional region is different from a second liquid-crystal alignment in a three-dimensional control region of the polarization control array corresponding to the three-dimensional region, and provide the image that is displayed two-dimensionally in at least a portion or three-dimensionally in at least a portion, based on degrees of refraction of light beams in the lens array after passing through the two-dimensional control region and the three-dimensional control region, respectively, each of the light beams having a polarization direction distinct from that of another light beam.

In addition, a program according to embodiments disclosed herein may be provided in a computer program product. The computer program product may be traded as commodities between sellers and buyers.

The computer program product may include a software program and a computer-readable recording medium storing the software program. For example, the computer program product may include a product (e.g., a downloadable application) in the form of a software program electronically distributed through a manufacturer of the electronic device or an electronic market (e.g., Samsung Galaxy Store). For electronic distribution, at least part of the software program may be stored in a storage medium or temporarily generated. In this case, the storage medium may be a storage medium of a server of the manufacturer of the electronic device, a server of the electronic market, or a relay server that temporarily stores the software program.

Although embodiments of the disclosure have been described with the limited embodiments and the drawings, various modifications and changes may be made by those of skill in the art from the above description. For example, suitable results may be obtained even when the described techniques are performed in a different order, or when components in a described electronic device, architecture, device, or circuit are coupled or combined in a different manner, or replaced or supplemented by other components or their equivalents.

1. An electronic device for providing an image to a display region, the electronic device comprising:
a display;
a lens array;
a polarization control array arranged between the display and the lens array, the polarization control array configured to control a polarization direction of light provided from the display;
at least one processor; and
memory storing a plurality of instructions, wherein the plurality of instructions, when executed by the at least one processor individually or collectively, cause the electronic device to:
obtain an input image and information about a two-dimensional display region and a three-dimensional display region of the input image,
generate, based on the input image and the information about the two-dimensional display region and the three-dimensional display region of the input image, a polarization information map comprising at least one of a two-dimensional region corresponding to the two-dimensional display region or a three-dimensional region corresponding to the three-dimensional display region,
synchronize the display and the polarization control array to simultaneously control the display to display the image via the display based on the input image, and
control the polarization control array to control a liquid-crystal alignment of the polarization control array based on the polarization information map,
control the polarization control array such that a first liquid-crystal alignment in a two-dimensional control region of the polarization control array corresponding to the two-dimensional region is different from a second liquid-crystal alignment in a three-dimensional control region of the polarization control array corresponding to the three-dimensional region, and
provide the image that is displayed two-dimensionally in at least a portion or three-dimensionally in at least a portion, based on degrees of refraction of light beams in the lens array after passing through the two-dimensional control region and the three-dimensional control region, respectively, each of the light beams having a polarization direction distinct from that of another light beam.

2. The electronic device of claim 1, wherein the plurality of instructions, when executed by the at least one processor individually or collectively, cause the electronic device to:
set a boundary region between the two-dimensional region and the three-dimensional region within the polarization information map, and
based on the polarization information map, apply a first voltage to the three-dimensional region or the two-dimensional region of the polarization control array , and apply a second voltage, which has a value between zero and the first voltage, to the boundary region of the polarization control array.

3. The electronic device of claim 1, wherein the display region comprises a first display region and a second display region,
the input image comprises a first input image to be displayed in the first display region, and a second input image to be displayed in the second display region, and
the plurality of instructions, when executed by the at least one processor individually or collectively, cause the electronic device to:
identify the two-dimensional display region based on detecting identical pixel value information at corresponding pixels between the first input image and the second input image, and
identify the three-dimensional display region based on detecting a difference in pixel value information at corresponding pixels between the first input image and the second input image .

4. The electronic device of claim 1, wherein the plurality of instructions, when executed by the at least one processor individually or collectively, cause the electronic device to receive image data comprising a first label value assigned to pixels corresponding to the two-dimensional display region, and a second label value assigned to pixels corresponding to the three-dimensional display region in the input image.

5. The electronic device of claim 1, wherein the plurality of instructions, when executed by the at least one processor individually or collectively, cause the electronic device to identify visual content in the input image, and identify the three-dimensional display region in the input image based on the identified visual content.

6. The electronic device of claim 1, wherein the plurality of instructions, when executed by the at least one processor individually or collectively, cause the electronic device to obtain information about a preset three-dimensional display region in the input image, and identify the three-dimensional display region based on the information about the preset three-dimensional display region.

7. The electronic device of claim 1, wherein the plurality of instructions, when executed by the at least one processor individually or collectively, cause the electronic device to:
activate a synchronization signal after the polarization information map is generated,
activate and input a first scan signal to the display in synchronization with the synchronization signal, and
activate and input a second scan signal to the polarization control array in synchronization with the synchronization signal.

8. The electronic device of claim 1, wherein the display comprises a first polarizing plate, a second polarizing plate having a polarization axis in a first polarization direction, and a first liquid-crystal layer arranged between the first polarizing plate and the second polarizing plate, and
the lens array comprises a liquid-crystal lens aligned in a direction orthogonal to the first polarization direction.

9. The electronic device of claim 1, wherein the display comprises a display element layer comprising a light-emitting element, and an upper polarizing plate arranged on the display element layer and having a polarization axis in a first polarization direction, and
the lens array comprises a liquid-crystal lens aligned in a direction orthogonal to the first polarization direction.

10. The electronic device of claim 1, wherein the polarization control array comprises a second liquid-crystal layer that is driven in a vertical alignment mode, and
the plurality of instructions, when executed by the at least one processor individually or collectively, cause the electronic device to, based on the polarization information map, apply no voltage to the two-dimensional control region of the polarization control array corresponding to the two-dimensional region, and apply a voltage to the three-dimensional control region of the polarization control array corresponding to the three-dimensional region.

11. The electronic device of claim 1, wherein the display comprises a plurality of pixels, each comprising a first sub-pixel that provides light of a first color, a second sub-pixel that provides light of a second color, and a third sub-pixel that provides light of a third color,
the polarization control array comprises a plurality of first electrodes and a plurality of second electrodes, the plurality of second electrodes intersecting the plurality of first electrodes on a plane,
a first width, in a first direction, of each of cells defined by the plurality of first electrodes and the plurality of second electrodes intersecting each other, and a second width, in the first direction, of each of the plurality of pixels are such that neither is an integer multiple of the other, and
a third width of each of the cells in a second direction that is orthogonal to the first direction, and a fourth width of each of the plurality of pixels in the second direction are such that neither is an integer multiple of the other.

12. The electronic device of claim 1, further comprising an anisotropic diffuser film arranged between the display and the polarization control array,
wherein the display comprises a plurality of pixels, each of the plurality of pixels comprising a first sub-pixel that provides light of a first color, a second sub-pixel that provides light of a second color, and a third sub-pixel that provides light of a third color,
in each of the plurality of pixels, the first sub-pixel, the second sub-pixel, and the third sub-pixel are arranged in a first direction, the first sub-pixels, the second sub-pixels, and the third sub-pixels of the plurality of pixels are respectively arranged in a second direction that is orthogonal to the first direction, and
a degree of diffusion of light by the anisotropic diffuser film in the second direction is greater than a degree of diffusion of light by the anisotropic diffuser film in the first direction.

13. An operating method of an electronic device for providing an image to a display region, the electronic device comprising a display, a lens array, and a polarization control array configured to control a polarization direction of light provided from the display, the operating method comprising:
obtaining an input image and information about a two-dimensional display region and a three-dimensional display region of the input image;
generating, based on the input image and the information about the two-dimensional display region and the three-dimensional display region of the input image, a polarization information map comprising at least one of a two-dimensional region corresponding to the two-dimensional display region or a three-dimensional region corresponding to the three-dimensional display region;
synchronizing the display and the polarization control array to simultaneously control the display to display the image via the display based on the input image, and control the polarization control array to control a liquid-crystal alignment of the polarization control array based on the polarization information map;
controlling the polarization control array such that a first liquid-crystal alignment in the two-dimensional control region of the polarization control array corresponding to the two-dimensional region is different from a second liquid-crystal alignment in the three-dimensional control region of the polarization control array corresponding to the three-dimensional region; and
providing the image that is displayed two-dimensionally in at least a portion or three-dimensionally in at least a portion, based on degrees of refraction of light beams in the lens array after passing through the two-dimensional control region and the three-dimensional control region, respectively, each of the light beams having a polarization direction distinct from that of another light beam.

14. The operating method of claim 13, further comprising setting a boundary region between the two-dimensional region and the three-dimensional region within the polarization information map,
wherein the controlling of the polarization control array such that the first liquid-crystal alignment in the two-dimensional control region is different from the second liquid-crystal alignment in the three-dimensional control region comprises, based on the polarization information map,
applying a first voltage to the three-dimensional region or the two-dimensional region of the polarization control array, and
applying a second voltage, which has a value between zero and the first voltage, to the boundary region of the polarization control array.

15. The operating method of claim 13, wherein the display region comprises a first display region and a second display region,
the input image comprises a first input image to be displayed in the first display region, and a second input image to be displayed in the second display region, and
the obtaining of the information about the two-dimensional display region and the three-dimensional display region of the input image comprises identifying the two-dimensional display region based on detecting identical pixel values at corresponding pixels between the first input image and the second input, and identifying the three-dimensional display region based on detecting a difference in pixel values at corresponding pixels between the first input image and the second input image.

16. The operating method of claim 13, wherein the obtaining of the information about the two-dimensional display region and the three-dimensional display region of the input image comprises receiving image data comprising a first label value assigned to pixels corresponding to the two-dimensional display region, and a second label value assigned to pixels corresponding to the three-dimensional display region in the input image.

17. The operating method of claim 13, wherein the obtaining of the information about the two-dimensional display region and the three-dimensional display region of the input image comprises:
identifying visual content in the input image; and
identifying the three-dimensional display region in the input image based on the identified visual content.

18. The operating method of claim 13, wherein the obtaining of the information about the two-dimensional display region and the three-dimensional display region of the input image comprises:
obtaining information about a preset three-dimensional display region in the input image; and
identifying the three-dimensional display region based on the information about the preset three-dimensional display region.

19. The operating method of claim 13, wherein the synchronizing of the display and the polarization control array to simultaneously control the display and the polarization control array comprises:
activating a synchronization signal after the polarization information map is generated;
activating and inputting a first scan signal to the display in synchronization with the synchronization signal, and
activating and inputting a second scan signal to the polarization control array in synchronization with the synchronization signal.

20. A non-transitory computer-readable recording medium having recorded therein instructions executable by at least one processor of an electronic device to cause the electronic device to:
obtain an input image and information about a two-dimensional display region and a three-dimensional display region of the input image,
generate, based on the input image and the information about the two-dimensional display region and the three-dimensional display region of the input image, a polarization information map comprising at least one of a two-dimensional region corresponding to the two-dimensional display region or a three-dimensional region corresponding to the three-dimensional display region,
synchronize the display and the polarization control array to simultaneously control the display to display the image via the display based on the input image,
control the polarization control array to control a liquid-crystal alignment of the polarization control array based on the polarization information map,
control the polarization control array such that a first liquid-crystal alignment in a two-dimensional control region of the polarization control array corresponding to the two-dimensional region is different from a second liquid-crystal alignment in a three-dimensional control region of the polarization control array corresponding to the three-dimensional region, and
provide the image that is displayed two-dimensionally in at least a portion or three-dimensionally in at least a portion, based on degrees of refraction of light beams in the lens array after passing through the two-dimensional control region and the three-dimensional control region, respectively, each of the light beams having a polarization direction distinct from that of another light beam.
